(19) United States
(12) Patent Application Publication
(10) Pub. No.: US 2012/0242631 A1
(43) Pub. Date: Sep. 27, 2012

(54) PLASMA DISPLAY DEVICE AND METHOD FOR DRIVING PLASMA DISPLAY PANEL

(76) Inventors: Kazuki Sawa, Osaka (JP); Tomoyuki Saito, Osaka (JP)

(21) Appl. No.: 13/514,194

(22) PCT Filed: Dec. 9, 2010
(86) PCT No.: PCT/JP2010/007159

§ 371 Date: Jun. 6, 2012

(30) Foreign Application Priority Data
Dec. 14, 2009 (JP) 2009-282502

(51) Int. Cl. G09G 3/28; G06F 3/038

(52) U.S. Cl. 345/204; 345/60

(57) ABSTRACT

A loading phenomenon in a plasma display panel is reduced. For this purpose, image signal processing circuit (41) includes number-of-lit-cells calculating section (60), load value calculating section (61) for calculating the load value in each discharge cell based on the calculation result by number-of-lit-cells calculating section (60), correction gain calculating section (62) for calculating the correction gain of each discharge cell based on the calculation result by load value calculating section (61), pattern detecting section (63) for determining the presence or the absence of occurrence of a loading phenomenon in a display image, adjusting coefficient generating section (65) for generating an adjusting coefficient based on the determination result of pattern detecting section (63), correction gain adjusting section (64) for generating a correction gain after adjustment by multiplying the correction gain by the adjusting coefficient, and correcting section (69) for correcting an image signal based on the correction gain after adjustment.

### TECHNICAL FIELD

The present invention relates to a plasma display apparatus used in a wall-mounted television or a large monitor, and a driving method for a plasma display panel.

### BACKGROUND ART

An alternating-current surface discharge type panel typical as a plasma display panel (hereinafter referred to as “panel”) has many discharge cells between a front plate and a rear plate that are faced to each other. The front plate has the following elements:
a plurality of display electrode pairs disposed in parallel on a front glass substrate; and
a dielectric layer and a protective layer for covering the display electrode pairs.
   Here, each display electrode pair is formed of a pair of scan electrode and sustain electrode.

The rear plate has the following elements:
a plurality of data electrodes disposed in parallel on a rear glass substrate;
a dielectric layer for covering the data electrodes;
a plurality of barrier ribs disposed on the dielectric layer in parallel with the data electrodes; and
phosphor layers disposed on the surface of the dielectric layer and on side surfaces of the barrier ribs.

The front plate and rear plate are faced to each other so that the display electrode pairs and the data electrodes three-dimensionally intersect, and are sealed. Discharge gas containing xenon with a partial pressure of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing waveform is applied to each scan electrode, and initializing discharge is caused in each discharge cell. Thus, wall charge required for a subsequent address operation is formed in each discharge cell, and a priming particle (an excitation particle for causing address discharge) for stably causing address discharge is generated.

In the address period, a scan pulse is sequentially applied to scan electrodes (hereinafter, this operation is referred to as “scan”), and an address pulse is selectively applied to data electrodes based on an image signal to be displayed. Thus, address discharge is caused between the scan electrode and the data electrode of the discharge cell to emit light, thereby producing wall charge in the discharge cell (hereinafter, this operation is collectively referred to as “address”).

In a sustain period, as many sustain pulses as a number determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Thus, light is emitted at a luminance corresponding to the luminance weight determined for each subfield. Thus, light is emitted at a luminance corresponding to the gradation value of an image signal in each discharge cell of the panel, and an image is displayed on the image display surface of the panel.

As one of subfield methods, the following driving method has been studied. In this driving method, in the initializing period of one of a plurality of subfields, an all-cell initializing operation of causing initializing discharge in all discharge cells is performed. In the initializing period of other subfields, a selective initializing operation of causing initializing discharge only in the discharge cell that has undergone sustain discharge in the immediately preceding sustain period is performed. The luminance (hereinafter, referred to as “luminance of black level”) in a black display region that does not cause sustain discharge is therefore determined only by weak light emission in the all-cell initializing operation. As a result, light emission that is not related to the gradation display can be minimized, and the contrast ratio of the display image can be improved.

When the driving load differs between display electrode pairs, the voltage drop of the driving voltage can differ between them, and the emission luminance of the discharge cell can differ between them though the image signals have the same luminance. Here, the driving load means impedance when a driver circuit applies driving voltage to an electrode. Therefore, a technology of changing the lighting pattern of the subfields in one field when the driving load differs between the display electrode pairs is disclosed (for example, Patent Literature 1).

As the screen of the panel has been enlarged and the definition of the panel has been enhanced, recently, the driving load of the panel is apt to increase. In such a panel, the difference in driving load caused between the display electrode pairs is also apt to increase, and the difference in voltage drop of the driving voltage is also apt to increase.

In the technology disclosed in patent literature 1, however, increase in difference in driving load between the display electrode pairs can change the brightness of the display image because the lighting pattern of the subfields must be changed more largely.

The brightness of the image displayed on the panel is one of important factors in determining the image display quality. Therefore, when the brightness of the display image varies unnaturally, the user can recognize the change as the image quality degradation.

In a panel where the screen is enlarged and the definition is enhanced, the user easily visually recognizes the variation in brightness of the display image. Therefore, in the plasma display apparatus using such a panel, it is preferable that the variation in brightness of the display image is minimized.

### CITATION LIST

### Patent Literature

PTL 1
Unexamined Japanese Patent Publication No. 2006-184843

### SUMMARY OF THE INVENTION

The plasma display apparatus of the present invention has the following elements:
a panel that has a plurality of discharge cells each of which includes a display electrode pair formed of a scan electrode and a sustain electrode and a plurality of pixels each of which includes a plurality of discharge cells for emitting lights in different colors; and
an image signal processing circuit for converting an input image signal into image data that indicates lighting or no lighting in each subfield in a discharge cell.
   The image signal processing circuit includes the following elements:
a number-of-lit-cells calculating section for calculating the number of discharge cells to be lit for each display electrode pair in each subfield;
a load value calculating section for calculating the load value of each discharge cell based on the calculation result by the number-of-lit-cells calculating section;
a correction gain calculating section for calculating the correction gain of each discharge cell based on the calculation result by the load value calculating section;
a pattern detecting section for determining a presence or an absence of occurrence of a loading phenomenon in a display image;
an adjusting coefficient generating section for generating an adjusting coefficient based on a determination result of the pattern detecting section;
a correction gain adjusting section for generating a correction gain after the adjustment by multiplying the correction gain by the adjusting coefficient; and
a correcting section for subtracting, from the input image signal, the result obtained by multiplying the input image signal by the correction gain after the adjustment.
   The pattern detecting section includes the following elements:
an adjacent pixel correlation determining section for determining correlation between the pixels adjacent to each other by comparing the gradation value assigned to each discharge cell in the pixel with that in its adjacent pixel;
a load value variation determining section for determining the load value variation by dividing the image display surface of the panel into a plurality of regions, by calculating a sum total of the load values in each of the plurality of regions, and by comparing the sum total of the load values in one of the regions with that in its adjacent region; and
a continuity determining section for determining the presence or the absence of occurrence of a loading phenomenon in a display image based on the result of the correlation determination by the adjacent pixel correlation determining section and the result of the load value variation determination.

Thus, the difference in driving load between display electrode pairs can be further accurately detected, and optimal loading correction corresponding to the lit state of the discharge cell can be performed. The loading correction can be performed only when an image where occurrence of the loading phenomenon is expected is displayed, by determining the presence or the absence of occurrence of the loading phenomenon in a display image in the pattern detecting section and by changing the correction gain output from the correction gain calculating section based on the determination result. Therefore, unnecessary variation in luminance in the display image is reduced and further accurate loading correction can be performed. Thus, in a plasma display apparatus using a panel of a large screen and high definition, the image display quality can be largely improved.

A driving method for a panel of the present invention is a driving method for a panel that has a plurality of discharge cells each of which includes a display electrode pair formed of a scan electrode and a sustain electrode and a plurality of pixels each of which includes a plurality of discharge cells for emitting lights in different colors. This driving method includes the following steps:
calculating the number of discharge cells to be lit for each display electrode pair in each subfield;
calculating a load value of each discharge cell based on the number of discharge cells to be lit and calculating the correction gain of each discharge cell based on the load value;
determining correlation by comparing a gradation value assigned to each discharge cell in a pixel with that in its adjacent pixel;
determining the load value variation by dividing the image display surface of the panel into a plurality of regions, by calculating a sum total of the load values in each of the plurality of regions, and by comparing the sum total of the load values in one of the regions with that in its adjacent region;
determining a presence or an absence of occurrence of a loading phenomenon in a display image based on the result of the correlation determination and the result of the load value variation determination;
generating an adjusting coefficient based on the result of the determination and generating a correction gain after the adjustment by multiplying the correction gain by the adjusting coefficient; and
multiplying the input image signal by the correction gain after the change, subtracting the multiplication result from the input image signal for correcting the input image signal.

Thus, the difference in driving load between display electrode pairs can be further accurately detected, optimal loading correction corresponding to the lit state of the discharge cell can be performed. The loading correction can be performed only when an image where occurrence of the loading phenomenon is expected is displayed, by determining the presence or the absence of occurrence of the loading phenomenon in a display image and by changing the correction gain based on the determination result. Therefore, unnecessary variation in luminance in the display image is reduced and further accurate loading correction can be performed. Thus, in a plasma display apparatus using a panel of a large screen and high definition, the image display quality can be largely improved.

### BRIEF DESCRIPTION OF DRAWINGS

FIG. 1 is an exploded perspective view showing a structure of a panel used in an exemplary embodiment of the present invention.

FIG. 2 is an electrode array diagram of the panel used in the exemplary embodiment of the present invention.

FIG. 3 is a waveform chart of driving voltage to be applied to each electrode of the panel in accordance with the exemplary embodiment of the present invention.

FIG. 4 is a circuit block diagram of a plasma display apparatus in accordance with the exemplary embodiment of the present invention.

FIG. 5A is a schematic diagram for illustrating a difference in emission luminance caused by variation in driving load.

FIG. 5B is a schematic diagram for illustrating another difference in emission luminance caused by variation in driving load.

FIG. 6A is a diagram for schematically illustrating a loading phenomenon.

FIG. 6B is a diagram for schematically illustrating another loading phenomenon.

FIG. 6C is a diagram for schematically illustrating yet another loading phenomenon.

FIG. 6D is a diagram for schematically illustrating still another loading phenomenon.

FIG. 7 is a diagram for schematically illustrating loading correction in accordance with the exemplary embodiment of the present invention.

FIG. 8 is a circuit block diagram of an image signal processing circuit in accordance with the exemplary embodiment of the present invention.

FIG. 9 is a schematic diagram for illustrating a calculating method of “load value” in accordance with the exemplary embodiment of the present invention.

FIG. 10 is a schematic diagram for illustrating a calculating method of “maximum load value” in accordance with the exemplary embodiment of the present invention.

FIG. 11 is a circuit block diagram of a pattern detecting section in accordance with the exemplary embodiment of the present invention.

FIG. 12 is a circuit block diagram of an adjacent pixel correlation determining section in accordance with the exemplary embodiment of the present invention.

FIG. 13 is a circuit block diagram of a load value variation determining section in accordance with the exemplary embodiment of the present invention.

FIG. 14 is a schematic diagram for illustrating an example of the operation of the load value variation determining section in accordance with the exemplary embodiment of the present invention.

FIG. 15 is a circuit block diagram of a continuity determining section in accordance with the exemplary embodiment of the present invention.

FIG. 16 is a circuit block diagram of a horizontal continuity determining section in accordance with the exemplary embodiment of the present invention.

FIG. 17 is a circuit block diagram of a vertical continuity determining section in accordance with the exemplary embodiment of the present invention.

FIG. 18 is a schematic diagram for illustrating an example of the operation of the vertical continuity determining section in accordance with the exemplary embodiment of the present invention.

FIG. 19 is a circuit block diagram of an adjusting coefficient generating section in accordance with the exemplary embodiment of the present invention.

FIG. 20 is a schematic diagram for illustrating an example of the operation of the adjusting coefficient generating section in accordance with the exemplary embodiment of the present invention.

FIG. 21 is a schematic diagram for illustrating another example of the generation of the adjusting coefficient in accordance with the exemplary embodiment of the present invention.

### DESCRIPTION OF EMBODIMENTS

A plasma display apparatus in accordance with an exemplary embodiment of the present invention will be described hereinafter with reference to the accompanying drawings.

### Exemplary Embodiment

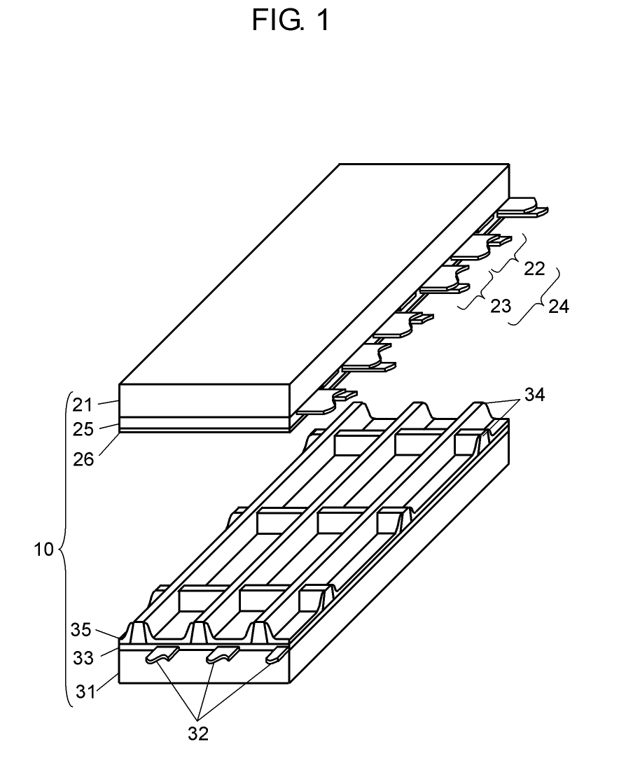

FIG. 1 is an exploded perspective view showing the structure of panel 10 used in a plasma display apparatus in accordance with an exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25. Protective layer 26 is made of a material mainly made of magnesium oxide (MgO).

A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting lights of respective colors of red (R), green (G), and blue (B) are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. In the present embodiment, discharge gas where xenon partial pressure is set at about 10% is employed for improving the luminous efficiency.

The discharge space is partitioned into a plurality of sections by barrier ribs 34. Discharge cells are formed in the intersecting parts of display electrode pairs 24 and data electrodes 32. The discharge cells discharge and emit light (lighting) to display a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B). Hereinafter, a discharge cell for emitting red light is referred to as an R discharge cell, a discharge cell for emitting green light is referred to as a G discharge cell, and a discharge cell for emitting blue light is referred to as a B discharge cell.

The structure of panel 10 is not limited to the above-mentioned one, but may be a structure having striped barrier ribs, for example. The mixing ratio of the discharge gas is not limited to the above-mentioned numerical value, but may be another mixing ratio.

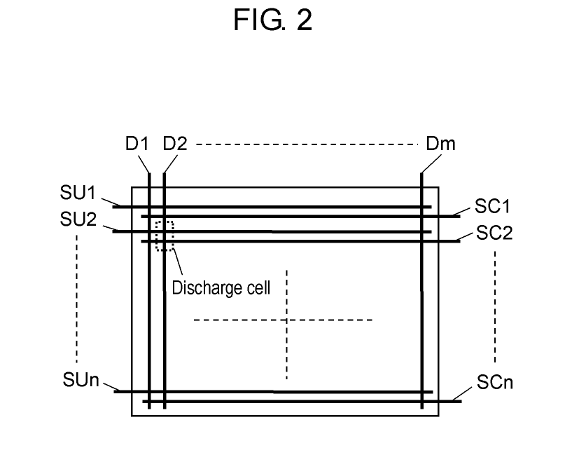

FIG. 2 is an electrode array diagram of panel 10 in accordance with the exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the row direction, and m data electrode D1 through data electrode Dm (data electrodes 32 in FIG. 1) extended in the column direction. A discharge cell is formed in the part where a pair of scan electrode SCi (j is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display surface of panel 10. In the panel where the number of pixels is 1920×1080, for example, m is 1920×3 and n is 1080.

Next, a driving voltage waveform and its operation for driving panel 10 are described schematically. The plasma display apparatus of the present embodiment performs gradation display by a subfield method. In this subfield method, the plasma display apparatus divides one field into a plurality of subfields on the time axis, and sets luminance weight for each subfield. Then, the plasma display apparatus controls light emission and no light emission of each discharge cell in each subfield, thereby displaying an image on panel 10.

In the present exemplary embodiment, for example, one field is formed of 8 subfields (first SF, second SF, . . . , eighth SF), and respective subfields have luminance weights of (1, 2, 4, 8, 16, 32, 64, 128) in ascending order where the luminance weight is larger in a later subfield. In this structure, the R signal, G signal, and B signal can be represented with 256 gradations of 0 to 255.

In the initializing period of one subfield, of a plurality of subfields, an all-cell initializing operation of causing the initializing discharge in all discharge cells is performed. In the initializing period of the other subfields, a selective initializing operation of selectively causing the initializing discharge in the discharge cell that has undergone sustain discharge in the sustain period of the immediately preceding subfield is performed. Thus, light emission related to no gradation display can be minimized, the emission luminance in a black region causing no sustain discharge can be reduced, and the contrast ratio of an image to be displayed on panel 10 can be increased. Hereinafter, a subfield where the all-cell initializing operation is performed is referred to as “all-cell initializing subfield”, and a subfield where the selective initializing operation is performed is referred to as “selective initializing subfield”.

In the present embodiment, the all-cell initializing operation is performed in the initializing period of the first SF, and the selective initializing operation is performed in the initializing periods of the second SF through eighth SF. Thus, light emission related to no image display is only light emission following the discharge of the all-cell initializing operation in the first SF. The luminance of black level, which is luminance in a black display region that does not cause sustain discharge, is therefore determined only by weak light emission in the all-cell initializing operation. This allows image display of sharp contrast on panel 10.

In a sustain period of each subfield, as many sustain pulses as the number derived by multiplying the luminance weight of each subfield by a predetermined proportionality constant are applied to each display electrode pair 24. The proportionality constant is luminance magnification.

In the present embodiment, the number of subfields that constitute one field and the luminance weight of each subfield are not limited to the above-mentioned values. The subfield structure may be changed based on an image signal or the like.

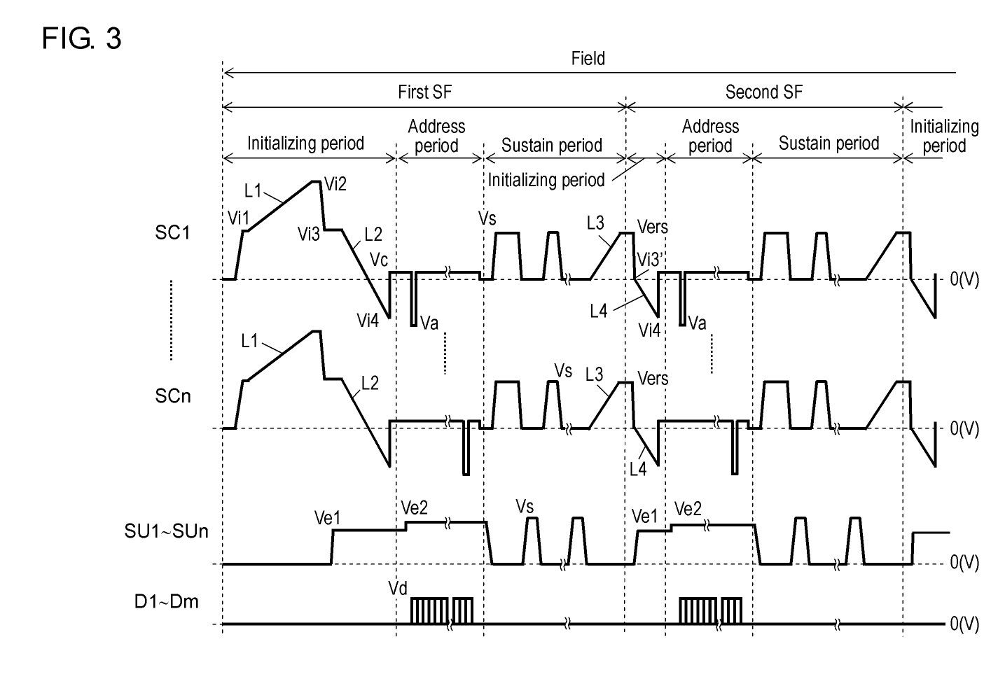

FIG. 3 is a waveform chart of driving voltage applied to each electrode of panel 10 in accordance with the exemplary embodiment of the present invention. FIG. 3 shows driving voltage waveforms of scan electrode SC1 for firstly performing an address operation in the address period, scan electrode SCn for finally performing the address operation in the address period, sustain electrode SU1 through sustain electrode SUn, and data electrode D1 through data electrode Dm.

FIG. 3 shows driving voltage waveforms of two subfields. These two subfields are a first subfield (first SF), which is an all-cell initializing subfield, and a second subfield (second SF), which is a selective initializing subfield. The driving voltage waveforms in other subfields are substantially similar to the driving voltage waveform in the second SF except that the number of sustain pulses in the sustain period is changed. Scan electrode SCi, sustain electrode SUi, and data electrode Dk described later are selected from the electrodes based on image data (which indicates lighting or no lighting in each subfield).

First, a first SF as the all-cell initializing subfield is described.

In the first half of the initializing period of the first SF, 0 (V) is applied to data electrode D1 through data electrode Dm and sustain electrode SU1 through sustain electrode SUn. Voltage Vi1 is applied to scan electrode SC1 through scan electrode SCn. Voltage Vi1 is set to be lower than a discharge start voltage with respect to sustain electrode SU1 through sustain electrode SUn. Ramp waveform voltage, which gently increases from voltage Vi1 to voltage Vi2, is applied to scan electrode SC1 through scan electrode SCn. This ramp waveform voltage is hereinafter referred to as “up-ramp voltage L1”. Voltage Vi2 is set to exceed the discharge start voltage with respect to sustain electrode SU1 through sustain electrode SUn. One example of the gradient of up-ramp voltage L1 is a numerical value of about 1.3 V/μsec.

While up-ramp voltage L1 increases, feeble initializing discharge continuously occurs between scan electrode SC1 through scan electrode SCn and sustain electrode SU1 through sustain electrode SUn, and feeble initializing discharge continuously occurs between scan electrode SC1 through scan electrode SCn and data electrode D1 through data electrode Dm. Negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrodes means voltage generated by the wall charge accumulated on the dielectric layer for covering the electrodes, the protective layer, or the phosphor layers.

In the latter half of the initializing period, positive voltage Ve1 is applied to sustain electrode SU1 through sustain electrode SUn, and 0 (V) is applied to data electrode D1 through data electrode Dm. Ramp waveform voltage, which gently decreases from voltage V13 to negative voltage Vi4, is applied to scan electrode SC1 through scan electrode SCn. This ramp waveform voltage is hereinafter referred to as “down-ramp voltage L2”. Voltage V13 is set to be lower than the discharge start voltage with respect to sustain electrode SU1 through sustain electrode SUn, and voltage Vi4 is set to exceed the discharge start voltage. One example of the gradient of down-ramp voltage L2 is a numerical value of about −2.5 V/μsec.

While down-ramp voltage L2 is applied to scan electrode SC1 through scan electrode SCn, feeble initializing discharge occurs between scan electrode SC1 through scan electrode SCn and sustain electrode SU1 through sustain electrode SUn, and feeble initializing discharge occurs between scan electrode SC1 through scan electrode SCn and data electrode D1 through data electrode Dm. The negative wall voltage on scan electrode SC1 through scan electrode SCn and the positive wall voltage on sustain electrode SU1 through sustain electrode SUn are reduced. The positive wall voltage on data electrode D1 through data electrode Dm is adjusted to a value appropriate for the address operation. Thus, the all-cell initializing operation of causing initializing discharge in all discharge cells is completed.

In the subsequent address period, scan pulses of voltage Va are sequentially applied to scan electrode SC1 through scan electrode SCn. An address pulse of positive voltage Vd is applied to data electrode Dk (k is 1 through m) corresponding to the discharge cell to emit light, of data electrode D1 through data electrode Dm. Thus, address discharge is selectively caused in each discharge cell.

Specifically, voltage Vet is firstly applied to sustain electrode SU1 through sustain electrode SUn, and voltage Vc (voltage Va+voltage Vsc) is applied to scan electrode SC1 through scan electrode SCn.

Then, a scan pulse of negative voltage Va is applied to scan electrode SC1 in the first row, an address pulse of positive voltage Vd is applied to data electrode Dk (k is 1 through m) in the discharge cell to emit light in the first row, of data electrode D1 through data electrode Dm. At this time, the voltage difference in the intersecting part of data electrode Dk and scan electrode SC1 is derived by adding the difference between the wall voltage on data electrode Dk and that on scan electrode SC1 to the difference (voltage Vd−voltage Va) of the external applied voltage. Thus, the voltage difference between data electrode Dk and scan electrode SC1 exceeds the discharge start voltage, and discharge occurs between data electrode Dk and scan electrode SC1.

Since voltage Ve2 is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (voltage Ve2−voltage Va) of the external applied voltage. At this time, by setting voltage Ve2 at a voltage value slightly lower than the discharge start voltage, a state where discharge does not occur but is apt to occur can be caused between sustain electrode SU1 and scan electrode SC1.

Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell to emit light, positive wall voltage is accumulated on scan electrode SC1, negative wall voltage is accumulated on sustain electrode SU1, and negative wall voltage is also accumulated on data electrode Dk.

Thus, the address operation of causing address discharge in the discharge cell to emit light in the first row and accumulating wall voltage on each electrode is performed. The voltage in the part where scan electrode SC1 intersects with data electrode 32 to which no address pulse has been applied does not exceed the discharge start voltage, so that address discharge does not occur. This address operation is performed until it reaches the discharge cell in the n-th row, and the address period is completed.

In the subsequent sustain period, as many sustain pulses as the number derived by multiplying the luminance weight by a predetermined luminance magnification are alternately applied to display electrode pairs 24, sustain discharge is caused to emit light in the discharge cell having undergone the address discharge.

In the sustain period, a sustain pulse of positive voltage Vs is firstly applied to scan electrode SC1 through scan electrode SCn, and the ground potential as a base potential, namely 0 (V), is applied to sustain electrode SU1 through sustain electrode SUn. In the discharge cell having undergone the address discharge, the voltage difference between scan electrode SCi and sustain electrode SUi is obtained by adding the difference between the wall voltage on scan electrode SCi and that on sustain electrode SUi to sustain pulse voltage Vs.

Thus, the voltage difference between scan electrode SCi and sustain electrode SUi exceeds the discharge start voltage, and sustain discharge occurs between scan electrode SCi and sustain electrode SUi. Ultraviolet rays generated by this discharge cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell where address discharge has not occurred in the address period, sustain discharge does not occur and the wall voltage at the end of the initializing period is kept.

Subsequently, 0 (V) as the base potential is applied to scan electrode SC1 through scan electrode SCn, and a sustain pulse is applied to sustain electrode SU1 through sustain electrode SUn. In the discharge cell having undergone the sustain discharge, the voltage difference between sustain electrode SUi and scan electrode SCi exceeds the discharge start voltage. Thus, sustain discharge occurs between sustain electrode SUi and scan electrode SCi again, negative wall voltage is accumulated on sustain electrode SUi, and positive wall voltage is accumulated on scan electrode SCi.

Hereinafter, similarly, as many sustain pulses as the number derived by multiplying the luminance weight by luminance magnification are alternately applied to scan electrode SC1 through scan electrode SCn and sustain electrode SU1 through sustain electrode SUn. Thus, sustain discharge is continuously performed in the discharge cell having undergone the address discharge in the address period.

After generation of a sustain pulse in the sustain period, ramp waveform voltage, which gently increases from 0 (V) to voltage Vers, is applied to scan electrode SC1 through scan electrode SCn while 0 (V) is applied to sustain electrode SU1 through sustain electrode SUn and data electrode D1 through data electrode Dm. This ramp waveform voltage is hereinafter referred to as “erasing ramp voltage L3”.

The gradient of erasing ramp voltage L3 is set to be steeper than that of up-ramp voltage L1. One example of the gradient of erasing ramp voltage L3 is a numerical value of about 10 V/μsec. By setting voltage Vers to be a voltage exceeding the discharge start voltage, feeble discharge occurs between sustain electrode SUi and scan electrode SCi of the discharge cell having undergone the sustain discharge. This feeble discharge continues while the applied voltage to scan electrode SC1 through scan electrode SCn increases beyond the discharge start voltage.

At this time, the charged particles generated by the feeble discharge are accumulated on sustain electrode SUi and scan electrode SCi so as to reduce the voltage difference between sustain electrode SUi and scan electrode SCi. Therefore, in the discharge cell having undergone the sustain discharge, a part or the whole of the wall voltage on scan electrode SCi and sustain electrode SUi is erased while positive wall voltage is left on data electrode Dk. In other words, the discharge caused by erasing ramp voltage L3 serves as “erasing discharge” of erasing unnecessary wall charge accumulated in the discharge cell having undergone the sustain discharge.

When the increasing voltage arrives at predetermined voltage Vers, the voltage applied to scan electrode SC1 through scan electrode SCn is decreased to 0 (V) as the base potential. Thus, the sustain operation in the sustain period is completed.

In the initializing period of the second SF, the driving voltage waveform where the first half of the initializing period of the first SF is omitted is applied to each electrode. Voltage Ve1 is applied to sustain electrode SU1 through sustain electrode SUn, and 0 (V) is applied to data electrode D1 through data electrode Dm. Down-ramp voltage L4, which gently decreases from voltage Vi3′ (for example, 0 (V)) to negative voltage Vi4, is applied to scan electrode SC1 through scan electrode SCn. Here, voltage Vi3′ is lower than the discharge start voltage, and negative voltage Vi4 exceeds the discharge start voltage. One example of the gradient of down-ramp voltage L4 is a numerical value of about −2.5 V/μsec.

Thus, feeble initializing discharge occurs in the discharge cell having undergone the sustain discharge in the sustain period of the immediately preceding subfield (the first SF in FIG. 3). Then, the wall voltages on scan electrode SCi and sustain electrode SUi are reduced, and the wall voltage on data electrode Dk is also adjusted to a value appropriate for the address operation. In the discharge cell having undergone no sustain discharge in the sustain period of the immediately preceding subfield, initializing discharge does not occur, and the wall charge at the end of the initializing period of the immediately preceding subfield is kept as it is. The initializing operation in the second SF thus becomes the selective initializing operation of causing initializing discharge in the discharge cell that has undergone sustain discharge in the sustain period of the immediately preceding subfield.

In the address period and sustain period of the second SF, a driving voltage waveform similar to that in the address period and sustain period of the first SF is applied to each electrode except for the number of sustain pulses. In each subfield of the third SF and later, a driving voltage waveform similar to that in the second SF is applied to each electrode except for the number of sustain pulses.

The outline of the driving voltage waveform applied to each electrode of panel 10 of the present embodiment has been described.

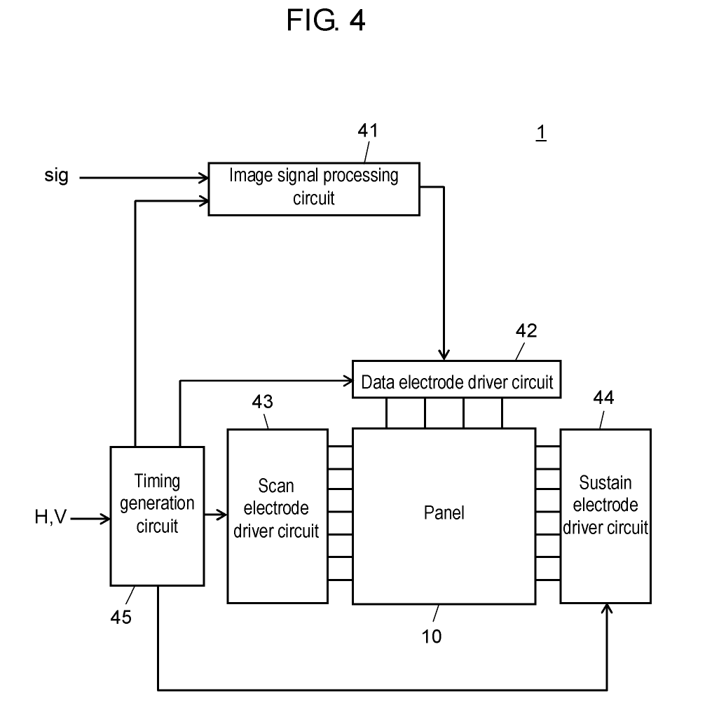

Next, a configuration of the plasma display apparatus of the present embodiment is described. FIG. 4 is a circuit block diagram of plasma display apparatus 1 of the exemplary embodiment of the present invention. Plasma display apparatus 1 has the following elements:
panel 10;
image signal processing circuit 41;
data electrode driver circuit 42;
scan electrode driver circuit 43;
sustain electrode driver circuit 44;
timing generation circuit 45; and
a power supply circuit (not shown) for supplying power required for each circuit block.

Image signal processing circuit 41 assigns a gradation value to each discharge cell based on input image signal sig. Then, image signal processing circuit 41 converts the gradation value into image data that indicates light emission or no light emission in each subfield.

For example, when input image signal sig includes an R signal, a G signal, and a B signal, image signal processing circuit 41 assigns each gradation value of R, G, and B to each discharge cell based on the R signal, the G signal, and the B signal. When input image signal sig includes a luminance signal (Y signal) and a chroma signal (C signal, R-Y signal and B-Y signal, or u signal and v signal), image signal processing circuit 41 calculates the R signal, the G signal, and the B signal based on the luminance signal and chroma signal, and then assigns each gradation value (gradation value represented in one field) of R, G, and B to each discharge cell. Image signal processing circuit 41 converts each gradation value of R, G, and B assigned to each discharge cell into image data that indicates light emission or no light emission in each subfield.

In the present exemplary embodiment, as described later, image signal processing circuit 41 corrects an image signal (this correction is referred to as “loading correction”). Image signal processing circuit 41 assigns each image data segment of R, G, and B to each discharge cell based on the corrected image signal.

Timing generation circuit 45 generates various timing signals for controlling operations of respective circuit blocks based on horizontal synchronizing signal H and vertical synchronizing signal V. Timing generation circuit 45 supplies the generated timing signals to respective circuit blocks (image signal processing circuit 41, data electrode driver circuit 42, scan electrode driver circuit 43, and sustain electrode driver circuit 44).

Scan electrode driver circuit 43 has an initializing waveform generation circuit, a sustain pulse generation circuit, and a scan pulse generation circuit (not shown). The initializing waveform generation circuit generates an initializing waveform to be applied to scan electrode SC1 through scan electrode SCn in the initializing period. The sustain pulse generation circuit generates a sustain pulse to be applied to scan electrode SC1 through scan electrode SCn in the sustain period. The scan pulse generation circuit has a plurality of scan electrode driver ICs (scan ICs), and generates a scan pulse to be applied to scan electrode SC1 through scan electrode SCn in the address period. Scan electrode driver circuit 43 drives each of scan electrode SC1 through scan electrode SCn based on the timing signal supplied from timing generation circuit 45.

Data electrode driver circuit 42 converts data in each subfield constituting the image data into a signal corresponding to each of data electrode D1 through data electrode Dm, and drives each of data electrode D1 through data electrode Dm based on the signal and the timing signal supplied from timing generation circuit 45.

Sustain electrode driver circuit 44 has a sustain pulse generation circuit and a circuit (not shown) for generating voltage Ve1 and voltage Vet, and drives sustain electrode SU1 through sustain electrode SUn based on the timing signal supplied from timing generation circuit 45.

Next, difference in emission luminance caused by variation in driving load is described.

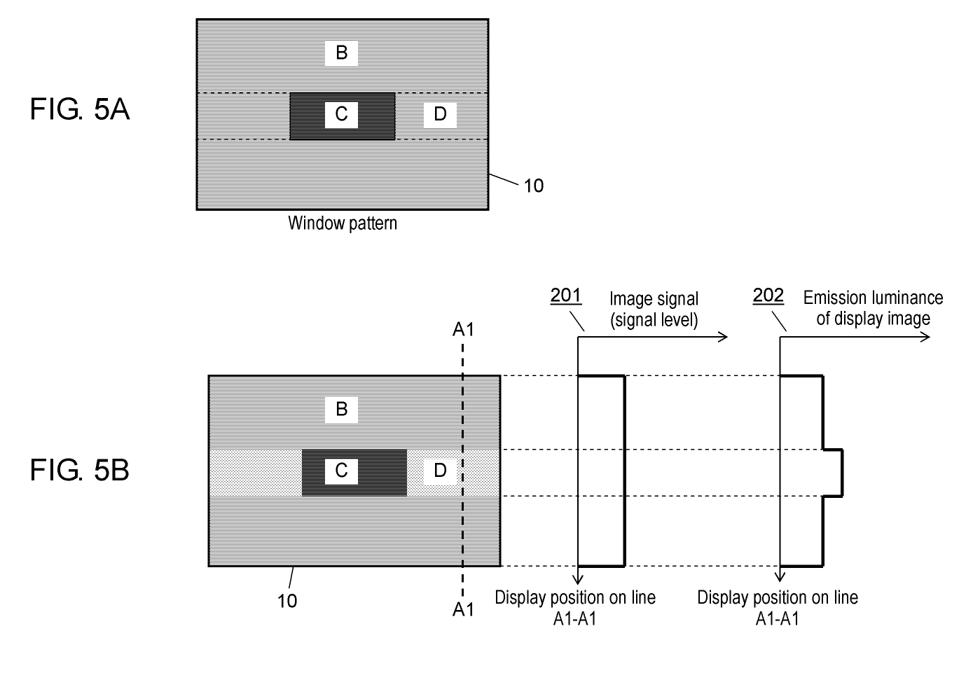

FIG. 5A and FIG. 5B are schematic diagrams for illustrating the difference in emission luminance caused by the variation in driving load. FIG. 5A shows an ideal display image when an image generally referred to as “window pattern” is displayed on panel 10. Region B and region D of the drawings have the same signal level (for example, 20%), and region C has a signal level (for example, 5%) lower than that of region B and region D. “Signal level” used in the present embodiment may be the gradation value of a luminance signal, or may be the gradation value of the R signal, the gradation value of the B signal, or the gradation value of the G signal.

FIG. 5B is a schematic diagram of the display image when “window pattern” of FIG. 5A is displayed on panel 10, and shows signal level 201 and emission luminance 202. In panel 10 of FIG. 5B, display electrode pairs 24 are arranged while being extended in the row direction (direction parallel with the long side of panel 10, and horizontal direction in the drawings) similarly to panel 10 of FIG. 2. Signal level 201 of FIG. 5B shows the signal level of the image signal on line A1-A1 shown on panel 10 of FIG. 5B. The horizontal axis shows the height of the signal level of the image signal, and the vertical axis shows the display position on line A1-A1 on panel 10. Emission luminance 202 of FIG. 5B shows the emission luminance of the display image on line A1-A1 shown on panel 10. The horizontal axis shows the height of the emission luminance of the display image, and the vertical axis shows the display position on line A1-A1 on panel 10.

When “window pattern” is displayed on panel 10 as shown in FIG. 5B, the emission luminance can differ between region B and region D as shown by emission luminance 202 although region B and region D have the same signal level as shown by signal level 201. This is considered for the following reason.

Display electrode pairs 24 are arranged while being extended in the row direction (direction parallel with the long side of panel 10, and horizontal direction in the drawings). Therefore, when “window pattern” is displayed on panel 10 as shown in panel 10 of FIG. 5B, display electrode pairs 24 passing only region B and display electrode pairs 24 passing region C and region D occur. The driving load of display electrode pairs 24 passing region C and region D is smaller than the driving load of display electrode pairs 24 passing region B. This is because the signal level and emission luminance of region C are lower than those of region B and hence the discharge current flowing through display electrode pairs 24 passing region C and region D is smaller than the discharge current flowing through display electrode pairs 24 passing region B.

Therefore, in display electrode pairs 24 passing region C and region D, the voltage drop of the driving voltage becomes smaller than that in display electrode pairs 24 passing region B. Therefore, the voltage drop of the sustain pulse, for example, in display electrode pairs 24 passing region C and region D also becomes smaller than that in display electrode pairs 24 passing region B. As a result, it is considered that the sustain discharge in the discharge cells included in region D has a discharge intensity higher than that of the sustain discharge in the discharge cells included in region B, and the emission luminance in region D is higher than that in region B although the signal levels in both regions are the same. Such a phenomenon is referred to as “loading phenomenon”. In other words, the loading phenomenon means that difference in driving load of display electrode pairs 24 for each row causes difference in emission luminance of the discharge cell for each row.

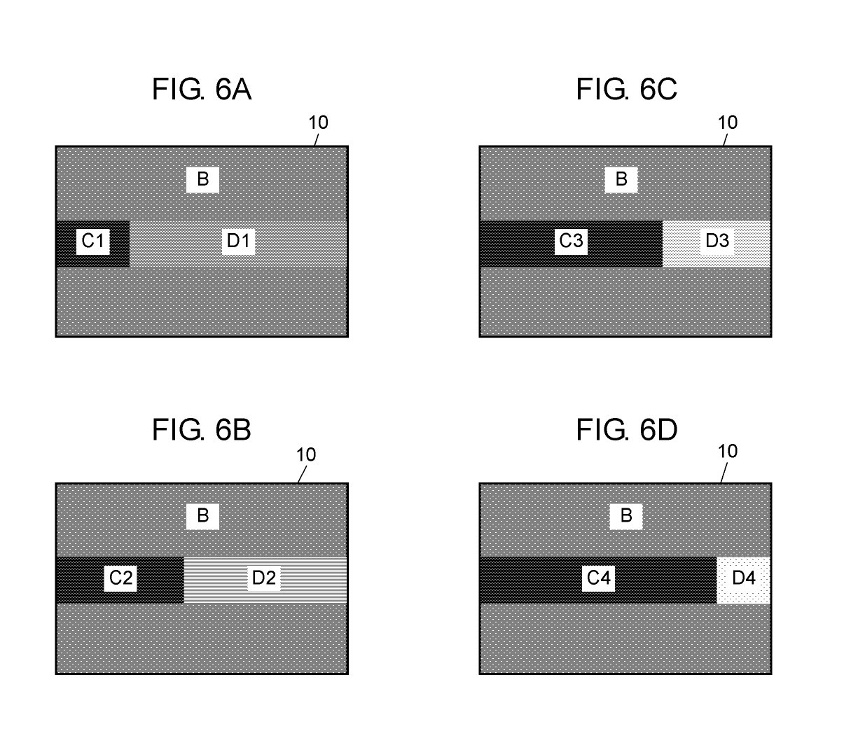

FIG. 6A, FIG. 6B, FIG. 6C, and FIG. 6D are diagrams for schematically illustrating the loading phenomenon. They schematically show the display image displayed on panel 10 while the area of region C where the signal level is low in “window pattern” is gradually varied. Region D1 in FIG. 6A, region D2 in FIG. 6B, region D3 in FIG. 6C, and region D4 in FIG. 6D have the same signal level (for example, 20%) as that of region B. Region C1 in FIG. 6A, region C2 in FIG. 6B, region C3 in FIG. 6C, and region C4 in FIG. 6D have the same signal level (for example, 5%).

As shown in FIG. 6A, FIG. 6B, FIG. 6C, and FIG. 6D, as the area of region C increases in the order of region C1, region C2, region C3, and region C4, the driving load of display electrode pairs 24 passing region C and region D decreases. As a result, the discharge intensity of the discharge cells included in region D gradually increases, and the emission luminance in region D gradually increases in the order of region D1, region D2, region D3, and region D4. The rate of increase in emission luminance by the loading phenomenon is varied by variation in driving load. The present embodiment reduces the loading phenomenon and improves the image display quality in plasma display apparatus 1. Processing of reducing the loading phenomenon is referred to as “loading correction”.

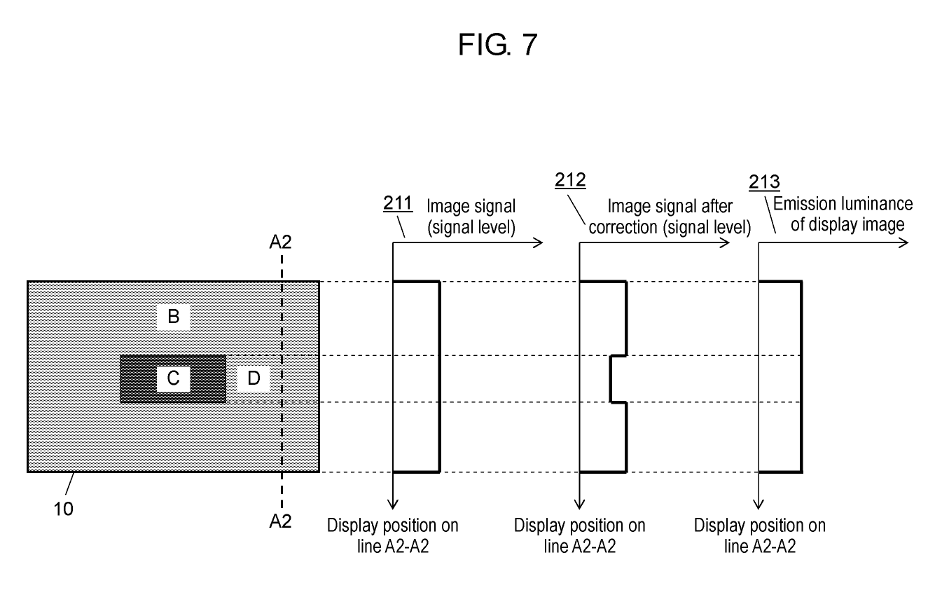

FIG. 7 is a diagram for schematically illustrating the loading correction in accordance with the exemplary embodiment of the present invention. FIG. 7 shows the schematic diagram of the display image when “window pattern” of FIG. 5A is displayed on panel 10, and shows signal level 211, signal level 212, and emission luminance 213. The display image shown on panel 10 of FIG. 7 is a schematic display image when “window pattern” of FIG. 5A is displayed on panel 10 after the loading correction of the present embodiment. Signal level 211 of FIG. 7 shows the signal level of the image signal on line A2-A2 on panel 10 of FIG. 7. The horizontal axis shows the height of the signal level of the image signal, and the vertical axis shows the display position on line A2-A2 on panel 10. Signal level 212 of FIG. 7 shows the signal level on line A2-A2 of the image signal after the loading correction of the present embodiment. The horizontal axis shows the height of the signal level of the image signal after the loading correction, and the vertical axis shows the display position on line A2-A2 on panel 10. Emission luminance 213 of FIG. 7 shows the emission luminance of the display image on line A2-A2 on panel 10. The horizontal axis shows the height of the emission luminance of the display image, and the vertical axis shows the display position on line A2-A2 on panel 10.

In the present embodiment, the loading correction is performed by calculating a correction value based on the driving load of display electrode pairs 24 passing each discharge cell, and correcting the image signal. For example, when the image shown by panel 10 of FIG. 7 is displayed on panel 10, the signal level is the same in region B and region D, but it can be determined that display electrode pairs 24 passing region D also pass region C and hence have a smaller driving load. Therefore, the signal level in region D is corrected as shown by signal level 212 of FIG. 7. Thus, as shown by emission luminance 213 of FIG. 7, the height of the emission luminance in region B in the display image is made equal to that in region D, thereby reducing the loading phenomenon.

Thus, the loading phenomenon is reduced by correcting the image signal in a region where the loading phenomenon is expected to occur and by reducing the emission luminance of the display image in this region. At this time, in the present embodiment, a pattern detecting section described later determines the presence or the absence of occurrence of the loading phenomenon in the display image, and generates a coefficient referred to as “adjusting coefficient” based the determination result. The pattern detecting section generates a correction gain after adjustment by multiplying the correction gain calculated to be used for loading correction by the adjusting coefficient, and performs the loading correction using the correction gain after adjustment.

The loading correction of the present embodiment is described in detail.

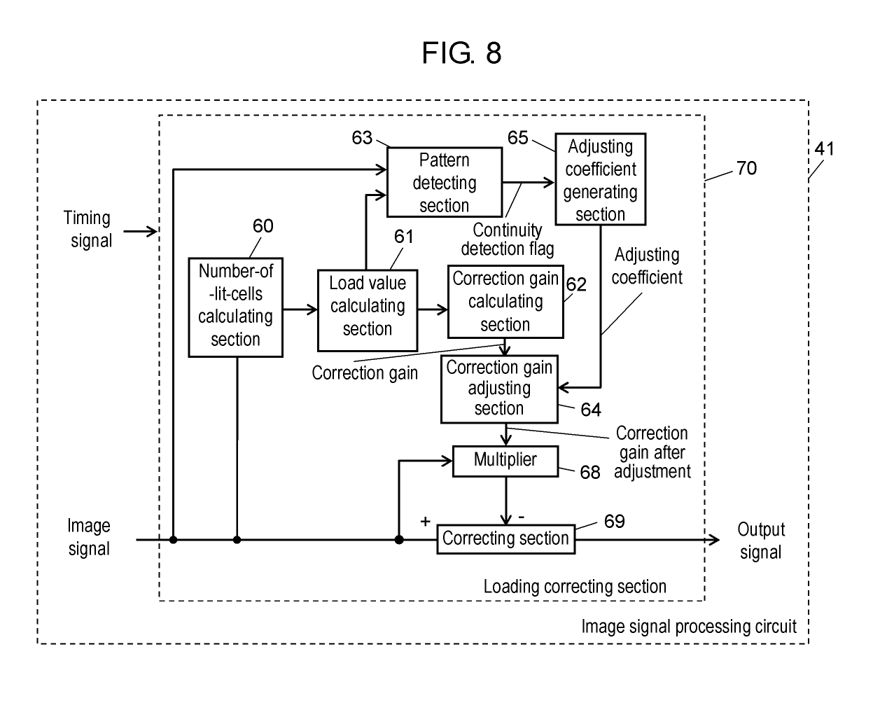

FIG. 8 is a circuit block diagram of image signal processing circuit 41 in accordance with the exemplary embodiment of the present invention. FIG. 8 shows a block related to the loading correction in the present embodiment, and circuit blocks other than this block are omitted.

Image signal processing circuit 41 has loading correcting section 70. Loading correcting section 70 includes number-of-lit-cells calculating section 60, load value calculating section 61, correction gain calculating section 62, pattern detecting section 63, correction gain adjusting section 64, adjusting coefficient generating section 65, multiplier 68, and correcting section 69.

Number-of-lit-cells calculating section 60 calculates the number of discharge cells to be lit for each display electrode pair 24 in each subfield. Hereinafter, a discharge cell to be lit is referred to as “lit cell”, and a discharge cell that is not to be lit is referred to as “unlit cell”.

Load value calculating section 61 receives the calculation result by number-of-lit-cells calculating section 60, and performs the operation based on a driving load calculating method of the present embodiment. The operation includes calculation of “load value” and “maximum load value” described later.

Correction gain calculating section 62 calculates the correction gain based on the operation result in load value calculating section 61.

Pattern detecting section 63 determines the presence or the absence of occurrence of the loading phenomenon in the display image based on the image signal and the operation result in load value calculating section 61, and outputs the determination result as “continuity detection flag”. Pattern detecting section 63 sets the continuity detection flag at “1” when the determination result is “presence”, namely when pattern detecting section 63 determines that a loading phenomenon occurs in a display image. Pattern detecting section 63 sets the continuity detection flag at “0” and outputs it when the determination result is “absence”, namely when pattern detecting section 63 determines that no loading phenomenon occurs in a display image. Details on pattern detecting section 63 are described later.

Adjusting coefficient generating section 65 generates an adjusting coefficient based on the continuity detection flag output from pattern detecting section 63. At this time, adjusting coefficient generating section 65 generates the adjusting coefficient so that the maximum value is “1” and the minimum value is “0”. When the determination result of pattern detecting section 63 changes from “absence” to “presence”, namely when the continuity detection flag changes from “0” to “1”, adjusting coefficient generating section 65 steeply increases the adjusting coefficient from “0” to “1”. When the determination result of pattern detecting section 63 changes from “presence” to “absence”, namely when the continuity detection flag changes from “1” to “0”, adjusting coefficient generating section 65 gently decreases the adjusting coefficient from “1” to “0”. Details on adjusting coefficient generating section 65 are described later.

Correction gain adjusting section 64 generates a correction gain after adjustment by multiplying the correction gain output from correction gain calculating section 62 by the adjusting coefficient output from adjusting coefficient generating section 65. Therefore, when the adjusting coefficient is “0” as the minimum value, the correction gain after adjustment is “0”. When the adjusting coefficient is “1” as the maximum value, the correction gain after adjustment is equal to the correction gain output from correction gain calculating section 62.

Multiplier 68 multiplies an input image signal by the correction gain after adjustment output from correction gain adjusting section 64, and outputs the multiplication result as a correction signal.

Correcting section 69 subtracts the correction signal output from multiplier 68 from the input image signal, and outputs the subtraction result as an image signal after correction.

Next, a calculating method of the correction gain of the present embodiment is described. In the present embodiment, this operation is performed by number-of-lit-cells calculating section 60, load value calculating section 61, and correction gain calculating section 62.

In the present embodiment, two numerical values referred to as “load value” and “maximum load value” are calculated based on the calculation result by number-of-lit-cells calculating section 60. “Load value” and “maximum load value” are numerical values used for estimating the occurring amount of the loading phenomenon in the discharge cell.

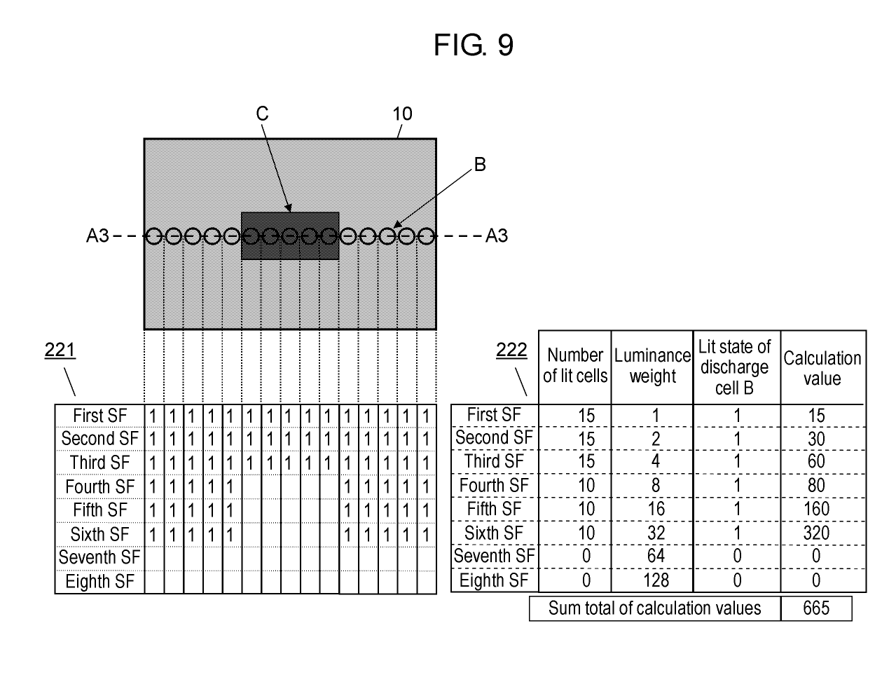

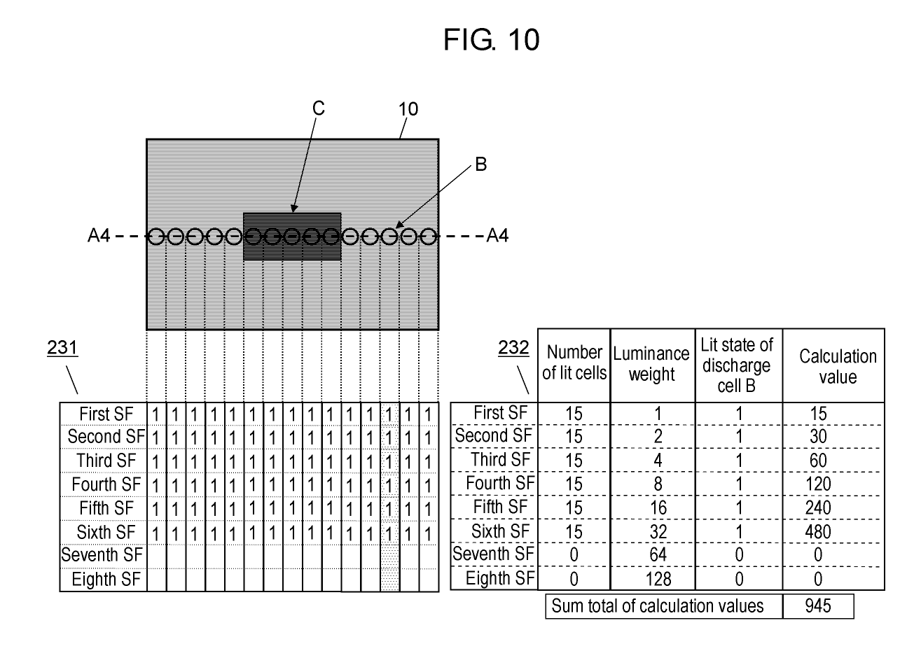

“Load value” of the present embodiment is firstly described using FIG. 9, and then “maximum load value” of the present embodiment is described using FIG. 10.

FIG. 9 is a schematic diagram for illustrating the calculating method of “load value” in accordance with the exemplary embodiment of the present invention. FIG. 9 shows a schematic diagram of the display image when “window pattern” of FIG. 5A is displayed on panel 10, and shows lit state 221 and calculation value 222. Lit state 221 of FIG. 9 schematically shows the lighting or no-lighting of each discharge cell on line A3-A3 on panel 10 of FIG. 9 in each subfield. The horizontal columns show display positions on line A3-A3 on panel 10, and the vertical columns show the subfields. “1” shows the lighting, and the blank columns show no lighting. Calculation value 222 of FIG. 9 schematically shows the calculating method of “load value” of the present embodiment. The horizontal columns show “number of lit cells”, “luminance weight”, “lit state of discharge cell B”, and “calculation value”, sequentially from the left of the diagram. The vertical columns show the subfields. In the present embodiment, for simplifying the description, the number of discharge cells of the row direction is 15. Therefore, 15 discharge cells are disposed on line A3-A3 on panel 10 of FIG. 9. Actually, each following operation is performed based on the number (for example, 1920×3) of discharge cells of the row direction of panel 10.

The lit state in each subfield of 15 discharge cells disposed on line A3-A3 on panel 10 of FIG. 9 is a state shown by lit state 221, for example. In other words, in the central five discharge cells included in region C shown by panel 10 of FIG. 9, lighting is performed in the first SF through third SF and no-lighting is performed in the fourth SF through eighth SF. In the five right discharge cells and the five left discharge cells that are not included in region C, lighting is performed in the first SF through sixth SF and no-lighting is performed in the seventh SF through eighth SF.

When 15 discharge cells disposed on line A3-A3 are in such a lit state, “load value” in one discharge cell of them is determined as follows. The one discharge cell is discharge cell B shown in FIG. 9, for example.

First, of 15 discharge cells disposed on line A3-A3, the number of lit sells in each subfield is calculated. In the example of FIG. 9, since all of 15 discharge cells on line A3-A3 are lit in the first SF through third SF, the number of lit cells in the first SF through third SF is “15”. Since 10 discharge cells, of 15 discharge cells on line A3-A3, are lit in the fourth SF through sixth SF, the number of lit cells in the fourth SF through sixth SF is “10”. Since none of 15 discharge cells on line A3-A3 is lit in the seventh SF through eighth SF, the number of lit cells in the seventh SF through eighth SF is “0”. In other words, columns of “number of lit sells” in calculation value 222 of FIG. 9 show “15” in the first SF through third SF, “10” in the fourth SF through sixth SF, and “0” in the seventh SF through eighth SF.

Next, the number of lit cells in each subfield that has been determined in that manner is multiplied by the luminance weight of each subfield and the lit state of each subfield in discharge cell B. This multiplication result is “calculation value” in the present embodiment. In the present embodiment, the luminance weights of respective subfields are set at (1, 2, 4, 8, 16, 32, 64, 128) sequentially from the first SF through the eighth SF as shown in respective columns of “luminance weight” in calculation value 222 of FIG. 9. In the present embodiment, lighting is denoted with “1”, and no lighting is denoted with “0”. The lit states in discharge cell B are (1, 1, 1, 1, 1, 1, 0, 0) sequentially from the first SF through the eighth SF as shown in respective columns of “lit state in discharge cell B” in calculation value 222. The multiplication results are (15, 30, 60, 80, 160, 320, 0, 0) sequentially from the first SF through the eighth SF as shown in respective columns of “calculation value” in calculation value 222. Then, the sum total of the calculation values is determined in the present embodiment. In the example shown in calculation value 222 of FIG. 9, the sum total of the calculation values is “665”. The sum total becomes “load value” in discharge cell B. In the present embodiment, such an operation is applied to each discharge cell to provide “load value” in each discharge cell.

FIG. 10 is a schematic diagram for illustrating a calculating method of “maximum load value” in accordance with the exemplary embodiment of the present invention. FIG. 10 shows a schematic diagram of the display image when “window pattern” of FIG. 5A is displayed on panel 10, and shows lit state 231 and calculation value 232. Lit state 231 of FIG. 10 schematically shows the lighting or no-lighting when the lit state in discharge cell B is assigned to all discharge cells on line A4-A4 on panel 10 of FIG. 10 in each subfield. The horizontal columns show the display positions on line A4-A4 on panel 10, and the vertical columns show the subfields. Calculation value 232 of FIG. 10 schematically shows the calculating method of “maximum load value” of the present embodiment. The horizontal columns show “number of lit cells”, “luminance weight”, “lit state of discharge cell B”, and “calculation value” sequentially from the left of FIG. 10. The vertical columns show the subfields.

In the present embodiment, “maximum load value” is calculated as follows. For example, when “maximum load value” in discharge cell B is calculated, it is assumed that all discharge cells on line A4-A4 are lit in the same state as that in discharge cell B as shown in lit state 231 of FIG. 10, and the number of lit cells in each subfield is calculated. The lit states of respective subfields in discharge cell B are (1, 1, 1, 1, 1, 1, 0, 0) sequentially from the first SF through the eighth SF as shown in respective columns of “lit state in discharge cell B” in calculation value 222 of FIG. 9. When the lit states are assigned to all discharge cells on line A4-A4, the lit states of all discharge cells on line A4-A4 are “1” in the first SF through sixth SF, and are “0” in the seventh SF and eighth SF as shown in the respective columns of lit state 231 of FIG. 10. Therefore, the numbers of lit cells are (15, 15, 15, 15, 15, 15, 0, 0) sequentially from the first SF through the eighth SF as shown in respective columns of “number of lit cells” in calculation value 232 of FIG. 10. In the present embodiment, however, each discharge cell on line A4-A4 is not actually put into the lit state shown in lit state 231. The lit state shown in lit state 231 shows the lit state when each discharge cell is assumed to come into the same lit state as that in discharge cell B in order to calculate “maximum load value”. The “number of lit cells” shown in calculation value 232 is obtained by calculating the number of lit cells under the assumption.

Next, the number of lit cells in each subfield that has been determined in that manner is multiplied by the luminance weight of each subfield and the lit state of each subfield in discharge cell B. In the present embodiment, the luminance weights of respective subfields are set to (1, 2, 4, 8, 16, 32, 64, 128) sequentially from the first SF through the eighth SF, as shown in respective columns of “luminance weight” in calculation value 232 of FIG. 10. The lit states in discharge cell B are (1, 1, 1, 1, 1, 1, 0, 0) sequentially from the first SF through the eighth SF as shown in respective columns of “lit state in discharge cell B” in calculation value 232. The multiplication results are (15, 30, 60, 120, 240, 480, 0, 0) sequentially from the first SF through the eighth SF as shown in respective columns of “calculation value” in calculation value 232. Then, the sum total of the calculation values is determined. In the example shown in calculation value 232 of FIG. 10, the sum total of the calculation values is “945”. This sum total becomes “maximum load value” in discharge cell B. In the present embodiment, such an operation is applied to each discharge cell to provide “maximum load value” in each discharge cell.

The “maximum load value” in discharge cell B may be calculated by the following steps:
multiplying the total number of discharge cells formed on display electrode pairs 24 by luminance weights of respective subfields;
multiplying the multiplication result by the lit states of respective subfields in discharge cell B; and
determining the sum total of the calculation values.
   This calculating method also allows the result similar to that of the above-mentioned operation. In the example of FIG. 10, the total number of discharge cells formed on display electrode pairs 24 is “15”, the luminance weights of respective subfields are (1, 2, 4, 8, 16, 32, 64, 128) sequentially from the first SF, and the lit states of respective subfields in discharge cell B are (1, 1, 1, 1, 1, 1, 0, 0) sequentially from the first SF. Therefore, the multiplication results of them are (15, 30, 60, 120, 240, 480, 0, 0) sequentially from the first SF. The sum total of the multiplication results is “945”, and is a result similar to that of the above-mentioned operation.

In the present embodiment, the correction gain in each discharge cell is calculated using a numerical value obtained from

(maximum load value−load value)/maximum load value equation (1)

For example, when “load value” is 665 and “maximum load value” is 945 in discharge cell B as discussed above, a numerical value can be obtained from

(945−665)/945=0.296

The correction gain is calculated by multiplying the calculated numerical value by a predetermined coefficient (predetermined coefficient in response to a characteristic or the like of the panel).

Correction gain=result of equation (1)×predetermined coefficient equation (2)

In the present embodiment, pattern detecting section 63 determines the presence or the absence of occurrence of the loading phenomenon in the display image, and adjusts the correction gain using the determination result. Pattern detecting section 63 firstly determines whether a pattern (occurrence of a loading phenomenon is expected) apt to cause a loading phenomenon is included in the display image. When it is determined that a pattern apt to cause a loading phenomenon is included in the display image, pattern detecting section 63 determines occurrence of the loading phenomenon in the display image, and sets the continuity detection flag as a signal representing the determination result at “1”. When it is determined that a pattern apt to cause a loading phenomenon is not included in the display image, pattern detecting section 63 determines no occurrence of the loading phenomenon in the display image, and sets the continuity detection flag at “0”. The continuity detection flag is output from pattern detecting section 63, and is input to adjusting coefficient generating section 65. Adjusting coefficient generating section 65 generates an adjusting coefficient based on the continuity detection flag. Correction gain adjusting section 64 multiplies the correction gain calculated in equation (2) by the adjusting coefficient as shown in

Correction gain after adjustment=correction gain×adjusting coefficient equation (3)

Thus, correction gain adjusting section 64 adjusts the correction gain generated in equation (2), and generates the correction gain after adjustment.

The maximum value of the adjusting coefficient is “1” and the minimum value is “0” as discussed above. Therefore, the maximum value of the magnitude of the correction gain after adjustment is equal to the value calculated in equation (2), and the minimum value is “0”. The correction gain after adjustment varies between the correction gain calculated in equation (2) and “0” in response to the magnitude of the adjusting coefficient.

Then, the correction gain after adjustment is substituted into equation (4) to correct an input image signal. Here, equation (4) is expressed as follows:

Output image signal=input image signal−input image signal×correction gain after adjustment equation (4)

Thus, in the present embodiment, the correction gain after adjustment is generated in response to the pattern of the display image and time variation of the pattern of the display image, and the loading correction is applied to the display image using the correction gain after adjustment.

In panel 10 where the screen has been recently enlarged and the definition has been enhanced, the driving load of scan electrodes 22 and sustain electrodes 23 is apt to increase. In plasma display apparatus 1 using such panel 10, the difference in driving load between display electrode pairs 24 is apt to increase dependently on the pattern of the display image, and the loading phenomenon is apt to occur.

In the present embodiment, however, by calculating “load value” and “maximum load value” as shown in equation (1) and equation (2) and using them for calculating the correction gain for loading correction, the correction gain responsive to the expected increase in emission luminance can be accurately calculated and the loading correction can be performed accurately. The average value (or maximum value, or minimum value, or intermediate value) of the correction gains calculated in discharge cells of R, G, and B may be used as the correction gain of the pixel so that the magnitude of the correction gain does not change in each discharge cell of R, G, and B constituting one pixel.

In the present embodiment, pattern detecting section 63 determines the presence or the absence of occurrence of the loading phenomenon in the display image, and generates an adjusting coefficient based on the continuity detection flag showing the determination result. The correction gain is multiplied by the adjusting coefficient to generate the correction gain after adjustment as shown in equation (3), and the loading correction is performed using the correction gain after adjustment as shown in equation (4). Thus, when an image where occurrence of a loading phenomenon is determined by pattern detecting section 63 is displayed, namely when the continuity detection flag is “1”, the correction gain after adjustment can be increased and loading correction can be applied to the display image. Otherwise, namely when the continuity detection flag is “0”, it is enabled that the correction gain after adjustment can be set at “0” to prevent loading correction from being applied to the display image.

In the present embodiment, when the continuity detection flag changes from “0” to “1”, namely when an image where occurrence of no loading phenomenon is determined is switched to an image where occurrence of a loading phenomenon is determined, the adjusting coefficient is steeply increased from “0” to “1”. Thus, the correction gain after adjustment can be steeply increased from “0” to the correction gain calculated by correction gain calculating section 62, and the loading correction can be rapidly applied to the display image when the image where occurrence of the loading phenomenon is determined is displayed.

In the present embodiment, when the loading correction is applied to the display image, the processing of multiplying the input image signal by the correction gain and subtracting the multiplication result from the input image signal is performed as shown in equation (4). Therefore, the brightness of the display image when the loading correction is not performed can differ from that when the loading correction is performed. In the present embodiment, however, the adjusting coefficient is gently decreased from “1” to “0” when the continuity detection flag changes from “1” to “0”, namely when an image where occurrence of a loading phenomenon is determined is switched to an image where occurrence of no loading phenomenon is determined. Thus, the correction gain after adjustment can be gently decreased from the correction gain calculated by correction gain calculating section 62 to “0”. Therefore, the display image is switched from the image where occurrence of a loading phenomenon is determined to the image where occurrence of no loading phenomenon is determined, the transition from the state where the loading correction is applied to the state where the loading correction is not applied can be moderated, and steep variation in luminance can be prevented from occurring in the display image.

The inventor has confirmed that, regarding the image where a loading phenomenon occurs, the variation in luminance is often difficult to be recognized even when the slight variation in luminance occurs, reduction of the loading phenomenon as fast as possible is preferable in increase the image display quality. Therefore, in the present embodiment, when the continuity detection flag changes from “0” to “1”, the adjusting coefficient is increased as rapidly as possible. These “steeply” and “gently” are specifically described later.

Next, details of pattern detecting section 63 are described.

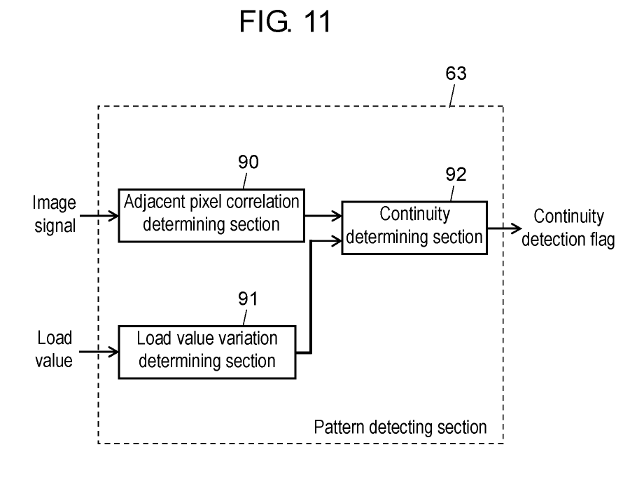

FIG. 11 is a circuit block diagram of pattern detecting section 63 in accordance with the exemplary embodiment of the present invention. Pattern detecting section 63 includes adjacent pixel correlation determining section 90, load value variation determining section 91, and continuity determining section 92.

Adjacent pixel correlation determining section 90 compares the gradation value assigned to each discharge cell in a pixel with that in its adjacent pixel, and performs correlation determination of whether or not the correlation between the adjacent pixels is high.

Load value variation determining section 91 determines the load value variation by dividing the image display surface of panel 10 into a plurality of regions, calculating the sum total of the load values in each of the plurality of regions based on the load values calculated by load value calculating section 61, and comparing the sum total of the load values in a region with that in its adjacent region.

Continuity determining section 92 determines the presence or the absence of occurrence of a loading phenomenon in a display image based on the result of the correlation determination by adjacent pixel correlation determining section 90 and the result of the load value variation determination by load value variation determining section 91.

Details of each circuit block constituting pattern detecting section 63 are described.

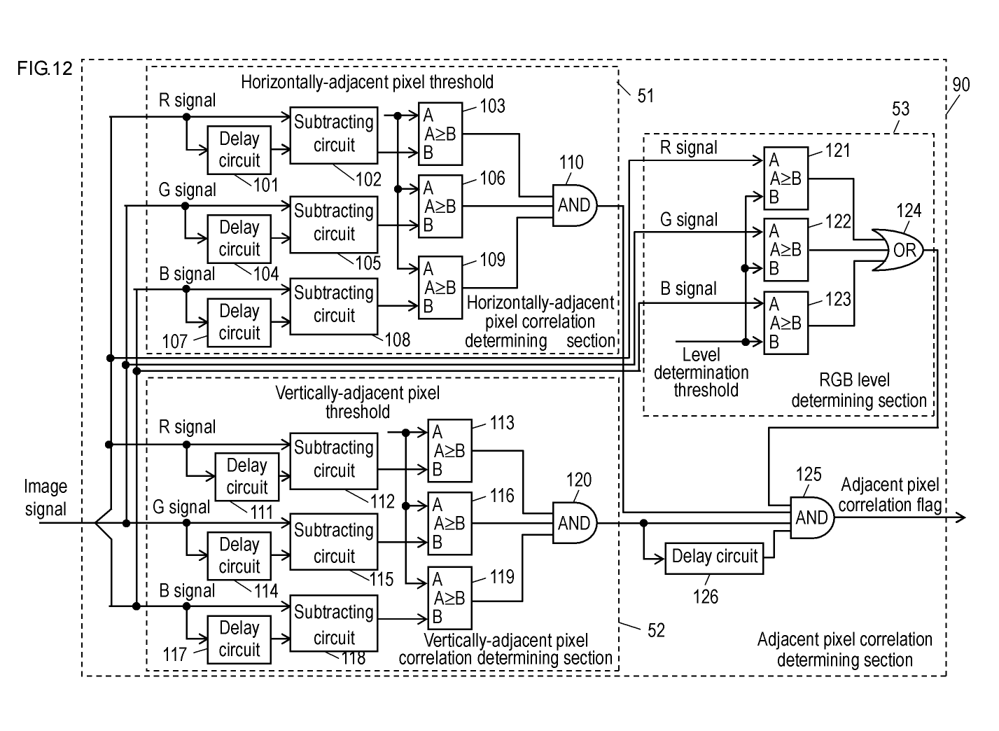

FIG. 12 is a circuit block diagram of adjacent pixel correlation determining section 90 in accordance with the exemplary embodiment of the present invention. Adjacent pixel correlation determining section 90 includes horizontally-adjacent pixel correlation determining section 51, vertically-adjacent pixel correlation determining section 52, RGB level determining section 53 as a gradation level determining section, delay circuit 126, and AND gate 125. Adjacent pixel correlation determining section 90 compares the gradation value in one pixel (hereinafter referred to as “target pixel”) with that in its adjacent pixel, and determines the correlation of the target pixel.

Horizontally-adjacent pixel correlation determining section 51 includes delay circuit 101, delay circuit 104, delay circuit 107, subtracting circuit 102, subtracting circuit 105, subtracting circuit 108, comparing circuit 103, comparing circuit 106, comparing circuit 109, and AND gate 110. Regarding two pixels, namely a target pixel and a pixel adjacent to the target pixel in the extending direction (hereinafter referred to as “horizontal direction”) of display electrode pairs 24, horizontally-adjacent pixel correlation determining section 51 determines the horizontally-adjacent pixel correlation by calculating the difference in gradation value between discharge cells of the same color and comparing the difference with a horizontally-adjacent pixel threshold.

Delay circuit 101 delays a red signal (R signal) of the image signal by a time corresponding to one pixel. The delay corresponding to one pixel can be expressed as a time derived by dividing the period of one field of the image signal by the number of pixels constituting panel 10 (for example, 1920×1080 pixels), for example.

Subtracting circuit 102 subtracts the gradation value of the R signal delayed by delay circuit 101 from the gradation value of the R signal, and outputs the absolute value of the subtraction result. Thus, subtracting circuit 102 can calculate the difference between the gradation values assigned to respective R discharge cells of two horizontally adjacent pixels.

Comparing circuit 103 compares the output of subtracting circuit 102 with a predetermined horizontally-adjacent pixel threshold. It outputs “1” when the output of subtracting circuit 102 is the horizontally-adjacent pixel threshold or lower, or outputs “0” otherwise. Thus, comparing circuit 103 can determine whether or not the correlation is high between the gradation values of the R signals in the R discharge cells of two horizontally adjacent pixels (whether the gradation values are numerical values similar to each other).

Delay circuit 104 delays the signal (G signal) of green of the image signal by the time corresponding to one pixel.

Subtracting circuit 105 subtracts the gradation value of the G signal delayed by delay circuit 104 from the gradation value of the G signal, and outputs the absolute value of the subtraction result. Thus, subtracting circuit 105 can calculate the difference between the gradation values assigned to respective G discharge cells of two horizontally adjacent pixels.

Comparing circuit 106 compares the output of subtracting circuit 105 with the horizontally-adjacent pixel threshold. It outputs “1” when the output of subtracting circuit 105 is the horizontally-adjacent pixel threshold or lower, or outputs “0” otherwise. Thus, comparing circuit 106 can determine whether or not the correlation is high between the gradation values of the G signals in the G discharge cells of two horizontally adjacent pixels.

Delay circuit 107 delays the signal (B signal) of blue of the image signal by the time corresponding to one pixel.

Subtracting circuit 108 subtracts the gradation value of the B signal delayed by delay circuit 107 from the gradation value of the B signal, and outputs the absolute value of the subtraction result. Thus, subtracting circuit 108 can calculate the difference between the gradation values assigned to respective B discharge cells of two horizontally adjacent pixels.

Comparing circuit 109 compares the output of subtracting circuit 108 with the horizontally-adjacent pixel threshold. It outputs “1” when the output of subtracting circuit 108 is the horizontally-adjacent pixel threshold or lower, or outputs “0” otherwise. Thus, comparing circuit 109 can determine whether or not the correlation is high between the gradation values of the B signals in the B discharge cells of two horizontally adjacent pixels.

AND gate 110 performs the logical product operation of the output of comparing circuit 103, the output of comparing circuit 106, and the output of comparing circuit 109. Therefore, AND gate 110 outputs “1” when all of the outputs of comparing circuit 103, comparing circuit 106, and comparing circuit 109 are “1”, or outputs “0” otherwise. The output of AND gate 110, namely the output of horizontally-adjacent pixel correlation determining section 51, is “1” when the correlation is high between the gradation values in all of the R discharge cells, G discharge cells, and B discharge cells in two pixels (the target pixel and a pixel horizontally adjacent to the target pixel). Otherwise, the output is “0”. Thus, horizontally-adjacent pixel correlation determining section 51 determines the horizontally-adjacent pixel correlation, namely whether or not the correlation between two horizontally adjacent pixels is high.

Vertically-adjacent pixel correlation determining section 52 includes delay circuit 111, delay circuit 114, delay circuit 117, subtracting circuit 112, subtracting circuit 115, subtracting circuit 118, comparing circuit 113, comparing circuit 116, comparing circuit 119, and AND gate 120. Regarding two pixels, namely the target pixel and a pixel adjacent to the target pixel in the direction (hereinafter referred to as “vertical direction”) orthogonal to display electrode pairs 24, vertically-adjacent pixel correlation determining section 52 determines the vertically-adjacent pixel correlation by calculating the difference in gradation value between discharge cells of the same color and comparing the difference with a vertically-adjacent pixel threshold.

Delay circuit 111 delays an R signal by one horizontal synchronizing period.

Subtracting circuit 112 subtracts the gradation value of the R signal delayed by delay circuit 111 from the gradation value of the R signal, and outputs the absolute value of the subtraction result. Thus, subtracting circuit 112 can calculate the difference between the gradation values assigned to respective R discharge cells of two vertically adjacent pixels.

Comparing circuit 113 compares the output of subtracting circuit 112 with a predetermined vertically-adjacent pixel threshold. It outputs “1” when the output of subtracting circuit 112 is the vertically-adjacent pixel threshold or lower, or outputs “0” otherwise. Thus, comparing circuit 113 can determine whether or not the correlation is high between the gradation values of the R signals in the R discharge cells of two vertically adjacent pixels.

Delay circuit 114 delays a G signal by one horizontal synchronizing period.

Subtracting circuit 115 subtracts the gradation value of the G signal delayed by delay circuit 114 from the gradation value of the G signal, and outputs the absolute value of the subtraction result. Thus, subtracting circuit 115 can calculate the difference between the gradation values assigned to respective G discharge cells of two vertically adjacent pixels.

Comparing circuit 116 compares the output of subtracting circuit 115 with the vertically-adjacent pixel threshold. It outputs “1” when the output of subtracting circuit 115 is the vertically-adjacent pixel threshold or lower, or outputs “0” otherwise. Thus, comparing circuit 116 can determine whether or not the correlation is high between the gradation values of the G signals in the G discharge cells of two vertically adjacent pixels.

Delay circuit 117 delays a B signal by one horizontal synchronizing period.

Subtracting circuit 118 subtracts the gradation value of the B signal delayed by delay circuit 117 from the gradation value of the B signal, and outputs the absolute value of the subtraction result. Thus, subtracting circuit 118 can calculate the difference between the gradation values assigned to respective B discharge cells of two vertically adjacent pixels.

Comparing circuit 119 compares the output of subtracting circuit 118 with the vertically-adjacent pixel threshold. It outputs “1” when the output of subtracting circuit 118 is the vertically-adjacent pixel threshold or lower, or outputs “0” otherwise. Thus, comparing circuit 119 can determine whether or not the correlation is high between the gradation values of the B signals in the B discharge cells of two vertically adjacent pixels.

AND gate 120 performs the logical product operation of the output of comparing circuit 113, the output of comparing circuit 116, and the output of comparing circuit 119. Therefore, AND gate 120 outputs “1” when all of the outputs of comparing circuit 113, comparing circuit 116, and comparing circuit 119 are “1”, or outputs “0” otherwise. The output of AND gate 120, namely the output of vertically-adjacent pixel correlation determining section 52, is “1” when the correlation is high between the gradation values in all of the R discharge cells, G discharge cells, and B discharge cells of two pixels (the target pixel and a pixel vertically adjacent to the target pixel). Otherwise, the output is “0”. Thus, vertically-adjacent pixel correlation determining section 52 determines the vertically-adjacent pixel correlation, namely whether or not the correlation between two vertically adjacent pixels is high.

RGB level determining section 53 includes comparing circuit 121, comparing circuit 122, comparing circuit 123, and OR gate 124. RGB level determining section 53 performs level determination by comparing the gradation value assigned to each of three discharge cells constituting the target pixel with a level determination threshold.

Comparing circuit 121 compares the gradation value of the R signal with a predetermined level determination threshold. Comparing circuit 121 outputs “1” when the gradation value of the R signal is the level determination threshold or higher, or outputs “0” otherwise.

Comparing circuit 122 compares the gradation value of the G signal with the level determination threshold. Comparing circuit 122 outputs “1” when the gradation value of the G signal is the level determination threshold or higher, or outputs “0” otherwise.

Comparing circuit 123 compares the gradation value of the B signal with the level determination threshold. Comparing circuit 123 outputs “1” when the gradation value of the B signal is the level determination threshold or higher, or outputs “0” otherwise.

OR gate 124 performs the logical sum operation of the output of comparing circuit 121, the output of comparing circuit 122, and the output of comparing circuit 123. Therefore, OR gate 124 outputs “1” when at least one of the outputs of comparing circuit 121, comparing circuit 122, and comparing circuit 123 is “1”, or outputs “0” otherwise. The output of OR gate 124, namely the output of RGB level determining section 53, is “1” for a pixel where at least one of the gradation values assigned to the R discharge cell, G discharge cell, and B discharge cell is the level determination threshold or higher, or “0” for the other pixels. Thus, RGB level determining section 53 performs level determination of the target pixel.

Delay circuit 126 delays the output of vertically-adjacent pixel correlation determining section 52 by the time corresponding to one pixel.

AND gate 125 performs the logical product operation of the output of horizontally-adjacent pixel correlation determining section 51 (the result of horizontally-adjacent pixel correlation determination by section 51), the output of vertically-adjacent pixel correlation determining section 52 (the result of vertically-adjacent pixel correlation determination by section 52), the output of RGB level determining section 53 (the result of level determination by section 53), and the output of delay circuit 126 (obtained by delaying the result of vertically-adjacent pixel correlation determination by section 52 by the time corresponding to one pixel). Therefore, AND gate 125 outputs “1” when all of the outputs of horizontally-adjacent pixel correlation determining section 51, vertically-adjacent pixel correlation determining section 52, RGB level determining section 53, and delay circuit 126 are “1”, or outputs “0” otherwise.

Thus, the output of AND gate 125, namely the output of adjacent pixel correlation determining section 90, is “1” under the following conditions:
the correlation is high between the gradation values in all of the R discharge cells, G discharge cells, and B discharge cells of two pixels, namely the target pixel and a pixel horizontally adjacent to the target pixel;
the correlation is high between the gradation values in all of the R discharge cells, G discharge cells, and B discharge cells of two pixels, namely the target pixel and a pixel vertically adjacent to the target pixel;
the correlation is high between the gradation values in all of the R discharge cells, G discharge cells, and B discharge cells of two pixels, namely a pixel horizontally adjacent to the target pixel and a pixel vertically adjacent to the pixel which is horizontally adjacent to the target pixel; and
the gradation value in at least one of the R discharge cell, G discharge cell, and B discharge cell of the target pixel is the level determination threshold or higher.
   The output of AND gate 125 is “0” otherwise. This operation is “correlation determination” by adjacent pixel correlation determining section 90. Adjacent pixel correlation determining section 90 applies the correlation determination to all pixels constituting the image display surface of panel 10, and outputs the result of the correlation determination for each pixel. In the present embodiment, the result of the correlation determination (output of adjacent pixel correlation determining section 90) is referred to as “adjacent pixel correlation flag”.

It is recognized that variation in brightness when a loading phenomenon occurs is easily visually recognized by a user in a region where pixels having a large gradation value and high correlation are concentrated. Adjacent pixel correlation determining section 90 performs the correlation determination in order to determine whether or not such a pattern is included in the display image.

In the present embodiment, for example, the horizontally-adjacent pixel threshold is set at 5% (the maximum value of the gradation value), the vertically-adjacent pixel threshold is set at 5% (the maximum value of the gradation value), and level determination threshold is set at 20% (the maximum value of the gradation value). In the present invention, the respective thresholds are not limited to these numerical values. Preferably, the respective thresholds are set optimally based on the characteristics of panel 10, the specification of plasma display apparatus 1, the visibility test of the display image, and the experiment of displaying an image apt to cause the loading phenomenon on panel 10.

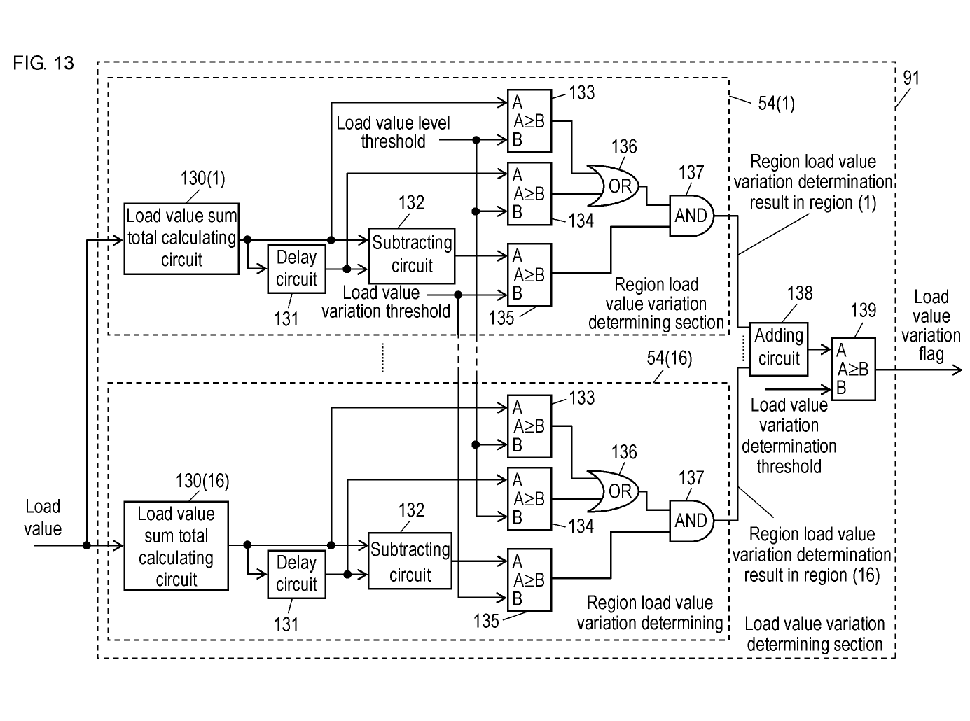

FIG. 13 is a circuit block diagram of load value variation determining section 91 in accordance with the exemplary embodiment of the present invention. Load value variation determining section 91 includes region load value variation determining section 54, adding circuit 138, and comparing circuit 139. Load value variation determining section 91 determines load value variation by comparing the sum total of the load values in a region with that in its vertically adjacent region. A set of all pixels formed on one display electrode pair 24 is hereinafter referred to as one line.

Load value variation determining section 91 sets a plurality of regions on one display electrode pair 24. Specifically, one line is divided into the plurality of regions so that the number of pixels in each region is the same. Load value variation determining section 91 calculates the sum total of the load values in each region, compares the sum total of the load values in a region with that in its vertically adjacent region, and determines the region load value variation. Therefore, load value variation determining section 91 includes as many region load value variation determining sections 54 as the regions set on one line. In the present exemplary embodiment, it is assumed that one line is divided into 16 regions (region (1) through region (16)) and load value variation determining section 91 includes 16 region load value variation determining sections 54 (region load value variation determining section 54(1) through region load value variation determining section 54(16)). This numerical value is simply one example in the present embodiment, and the present invention is not limited to this numerical value. The number of pixels in each region is preferably the same, but some variations are allowed.

Region load value variation determining section 54(1) for determining the region load value variation of region (1) is described as an example.

Region load value variation determining section 54(1) includes load value sum total calculating circuit 130 (1), delay circuit 131, subtracting circuit 132, comparing circuit 133, comparing circuit 134, comparing circuit 135, OR gate 136, and AND gate 137. Region load value variation determining section 54(1) determines the region load value variation in region (1).

Load value sum total calculating circuit 130 (1) integrates the load values output from load value calculating section 61 in one region (region (1)), of 16 regions into which one line is divided, and calculates the sum total of the load values in region (1).

Delay circuit 131 delays the output of load value sum total calculating circuit 130 (1) by one horizontal synchronizing period.

Subtracting circuit 132 subtracts the output of load value sum total calculating circuit 130 (1) delayed by delay circuit 131 from the output of load value sum total calculating circuit 130 (1), and outputs the absolute value of the subtraction result. Thus, subtracting circuit 132 can calculate the difference in the sum total of the load values between two vertically adjacent regions. Here, the difference is variation amount of the sum total of the load values.

Comparing circuit 135 compares the output of subtracting circuit 132 with a predetermined load value variation threshold. Comparing circuit 135 outputs “1” when the output of subtracting circuit 132 is the load value variation threshold or higher, or outputs “0” otherwise. Thus, comparing circuit 135 can determine whether or not the sum total of the load values largely differs (beyond the load value variation threshold) between region (1) and region (1)′ vertically adjacent to region (1).

Comparing circuit 133 compares the output of load value sum total calculating circuit 130 (1) with a load value level threshold. Comparing circuit 133 outputs “1” when the output of load value sum total calculating circuit 130 (1) is the load value level threshold or higher, or outputs “0” otherwise.

Comparing circuit 134 compares the output of load value sum total calculating circuit 130 (1) delayed by delay circuit 131 with the load value level threshold. Comparing circuit 134 outputs “1” when the output of load value sum total calculating circuit 130 (1) delayed by delay circuit 131 is the load value level threshold or higher, or outputs “0” otherwise.

OR gate 136 performs the logical sum operation of the output of comparing circuit 133 and the output of comparing circuit 134. AND gate 137 performs the logical product operation of the output of OR gate 136 and the output of comparing circuit 135. Therefore, AND gate 137 outputs “1” when the output of comparing circuit 135 is “1” and at least one of the output of comparing circuit 133 and the output of comparing circuit 134 is “1”, or outputs “0” otherwise. Thus, the output of AND gate 137, namely the output of region load value variation determining section 54(1), is “1” under the following conditions:
the difference in sum total of the load values between region (1) and region (1)′ vertically adjacent to region (1) is the load value variation threshold or higher; and
at least one of the sum total of the load values in region (1) and the sum total of the load values in region (1)′ is the load value level threshold or higher.
   The output of AND gate 137 is “0” otherwise. Thus, region load value variation determining section 54(1) determines whether or not the sum total of the load values significantly differs between region (1) and region (1)′. This determination is “region load value variation determination” in region load value variation determining section 54(1).

The configuration and operation of each of region load value variation determining section 54(2) through region load value variation determining section 54(16) in each of region (2) through region (16) are the same as those of region load value variation determining section 54(1) except for the region as the target of the region load value variation determination. Therefore, the descriptions of region load value variation determining section 54(2) through region load value variation determining section 54(16) are omitted (region load value variation determining section 54(2) through region load value variation determining section 54(15) are not shown).

Adding circuit 138 integrates the outputs of region load value variation determining section 54(1) through region load value variation determining section 54(16). In other words, adding circuit 138 integrates the results of the region load value variation determination in all regions set on one line (in the present embodiment, 16 regions of region (1) through region (16)).

Comparing circuit 139 compares the integration result output from adding circuit 138 with a predetermined load value variation determination threshold. Comparing circuit 139 outputs “1” when the output of adding circuit 138 is the load value variation determination threshold or higher, or outputs “0” otherwise. This operation is “load value variation determination” in load value variation determining section 91. Load value variation determining section 91 performs the load value variation determination for all lines, and outputs the result of the load value variation determination for each line. In the present embodiment, the result (output of load value variation determining section 91) of the load value variation determination is referred to as “load value variation flag”. Thus, load value variation determining section 91 detects vertically adjacent lines between which the load value differs significantly.

For example, when an image having a pattern where a dark character is displayed on a bright background is displayed, it has been recognized that the load value varies largely on the line corresponding to the boundary between the background and the character and a loading phenomenon is apt to occur on the line as the boundary. The purpose of the load value variation determination by load value variation determining section 91 is to detect whether or not a pattern apt to cause the loading phenomenon is included in the display image.

In the configuration of the present embodiment, for example, the load value variation threshold is set at 10% (the maximum value calculated by load value sum total calculating circuit 130), the load value level threshold is set at 20% (the maximum value calculated by load value sum total calculating circuit 130), and the load value variation determination threshold is set at 25% (the maximum value calculated by adding circuit 138). In the present invention, the respective thresholds are not limited to these numerical values. Preferably, the respective thresholds are set optimally based on the characteristics of panel 10, the specification of plasma display apparatus 1, the visibility test of the display image, and the experiment of displaying an image apt to cause the loading phenomenon on panel 10.

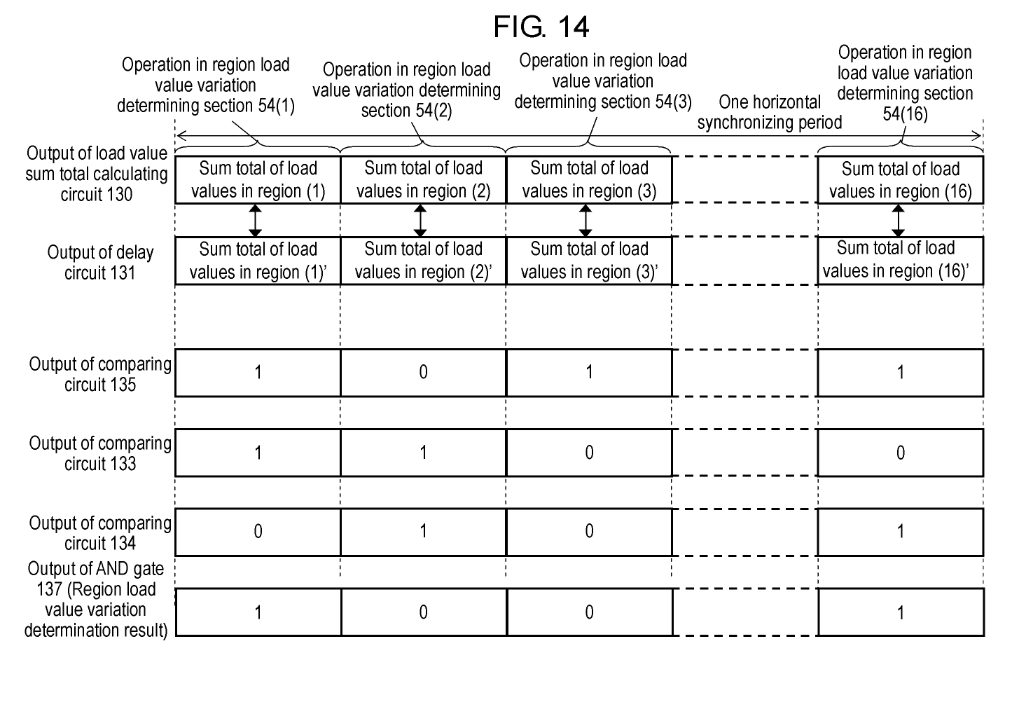

One example of the operation in load value variation determining section 91 is described using drawings. FIG. 14 is a schematic diagram for illustrating an example of the operation of load value variation determining section 91 in accordance with the exemplary embodiment of the present invention. FIG. 14 shows the output of load value sum total calculating circuit 130, the output of delay circuit 131, the output of comparing circuit 135, the output of comparing circuit 133, the output of comparing circuit 134, and the output of AND gate 137, in each of region load value variation determining section 54(1), region load value variation determining section 54(2), region load value variation determining section 54(3), and region load value variation determining section 54(16).

For example, when the sum total of the load values in region (1) is compared with that in region (1)′ vertically adjacent to region (1) and the variation amount of the sum total of load values is the load value variation threshold or higher, “1” is output from comparing circuit 135 of region load value variation determining section 54(1). In the example of FIG. 14, it is assumed that “1” is output also from comparing circuits 135 of region load value variation determining section 54(3) and region load value variation determining section 54(16).

When the sum total of load values in region (1) is the load value level threshold or higher, “1” is output from comparing circuit 133 of region load value variation determining section 54(1). In the example of FIG. 14, it is assumed that “1” is output from comparing circuit 134 of region load value variation determining section 54(16) and “1” is also output from comparing circuit 133 and comparing circuit 134 of region load value variation determining section 54(2).

In region load value variation determining section 54(1), both the outputs of comparing circuit 135 and comparing circuit 133 are “1”, and hence the output of AND gate 137 is “1”. This result indicates that the sum total of the load values in region (1) is significantly larger than that in region (1)′.

Similarly, in region load value variation determining section 54(16), both the outputs of comparing circuit 135 and comparing circuit 134 are “1”, and hence the output of AND gate 137 is “1”. This result indicates that the sum total of the load values in region (16) is significantly smaller than that in region (16)′.

In region load value variation determining section 54(3), the output of comparing circuit 135 is “1” but both the outputs of comparing circuit 133 and comparing circuit 134 are “0”, and hence the output of AND gate 137 is “0”. This result indicates the following phenomenon. The sum total of the load values differs between region (3) and region (3)′ by the load value variation threshold or higher, but the sum total of the load values is lower than the load value level threshold in both region (3) and region (3)′, so that this variation is not large enough to cause the loading phenomenon.

In region load value variation determining section 54(2), the outputs of comparing circuit 133 and comparing circuit 134 are “1” but the output of comparing circuit 135 is “0”, and hence the output of AND gate 137 is “0”. This result indicates that, the sum total of the load values is the load value level threshold or higher in both region (2) and region (2)′ but the sum total of the load values differs between region (2) and region (2)′ only by a value lower than the load value variation threshold.

Load value variation determining section 91 integrates the results (outputs of AND gate 137) of region load value variation determination of respective region load value variation determining sections 54, compares the integration result with the load value variation determination threshold, and determines load value variation.

Thus, load value variation determining section 91 can detect a line having many regions where the result of region load value variation determination is “1”, namely a line having many regions where the sum total of the load values increases or decreases largely. Thus, for example, in the image having a pattern where a dark character is displayed on a bright background, the line corresponding to the boundary between the background and the character can be detected.

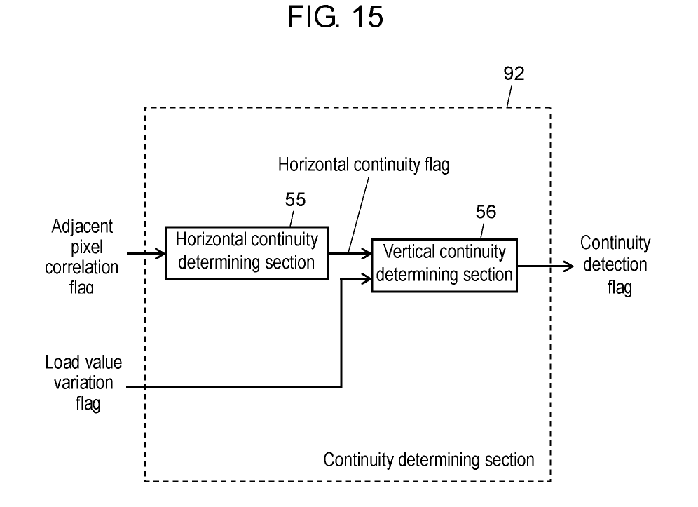

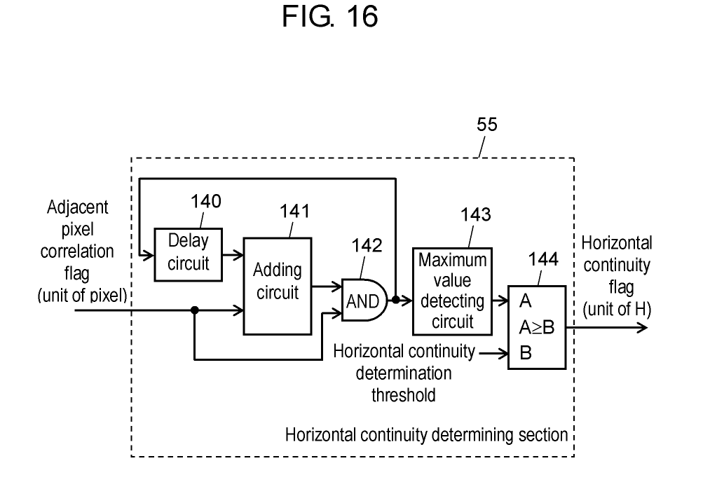

Next, continuity determining section 92 is described. FIG. 15 is a circuit block diagram of continuity determining section 92 in accordance with the exemplary embodiment of the present invention. Continuity determining section 92 includes horizontal continuity determining section 55 and vertical continuity determining section 56, and determines the presence or the absence of occurrence of a loading phenomenon in a display image.

Horizontal continuity determining section 55 determines the horizontal continuity based on the adjacent pixel correlation flag output from adjacent pixel correlation determining section 90, and outputs the determination result. In the present embodiment, the result of the horizontal continuity determination (output of horizontal continuity determining section 55) is referred to as “horizontal continuity flag”.

Vertical continuity determining section 56 determines the presence or the absence of occurrence of a loading phenomenon in a display image based on the load value variation flag output from load value variation determining section 91 and the horizontal continuity flag output from horizontal continuity determining section 55, and outputs the result. In the present embodiment, the determination result (output of vertical continuity determining section 56) is referred to as “continuity detection flag”. The continuity detection flag output from vertical continuity determining section 56 becomes an output of pattern detecting section 63.

FIG. 16 is a circuit block diagram of horizontal continuity determining section 55 in accordance with the exemplary embodiment of the present invention. Horizontal continuity determining section 55 includes delay circuit 140, adding circuit 141, AND gate 142, maximum value detecting circuit 143, and comparing circuit 144.

Delay circuit 140, adding circuit 141, and AND gate 142 constitute a circuit for integrating the adjacent pixel correlation flag output from adjacent pixel correlation determining section 90 for each pixel. Specifically, adding circuit 141 adds the output of delay circuit 140 for delaying an input signal by a time corresponding to one pixel to the adjacent pixel correlation flag. The addition result output from adding circuit 141 is input to delay circuit 140 via AND gate 142. Adding circuit 141 adds a new adjacent pixel correlation flag to the output of delay circuit 140. By repetition of a series of these operations, the adjacent pixel correlation flag is integrated in the line direction for each pixel.

AND gate 142 performs the logical product operation of the output of adding circuit 141 and the adjacent pixel correlation flag, and resets the integration value of the adjacent pixel correlation flag to “0” when the adjacent pixel correlation flag is “0”. Thus, the output of AND gate 142 indicates the repetition count of the state where the adjacent pixel correlation flag is “1”, namely indicates the number of horizontally consecutive pixels having an adjacent pixel correlation flag of “1”, and indicates how many pixels of high correlation with their adjacent pixels are consecutively arranged in the horizontal direction.

AND gate 142 resets the integration value of the adjacent pixel correlation flag to “0” for each line. Therefore, the maximum value of the output of AND gate 142 becomes equal to the number of pixels on one line. This reset can be performed by setting the adjacent pixel correlation flag at “0” when the line is switched (the present line is switched to the next line), for example.

Maximum value detecting circuit 143 detects the maximum value of the output of AND gate 142 for each line. For example, when the numerical value output from AND gate 142 changes in the sequence of “100”, “250”, and “80” in the period of one line, the maximum value, “250”, becomes the output of maximum value detecting circuit 143. In other words, the output of maximum value detecting circuit 143 indicates the maximum value of the number of horizontally consecutive pixels having an adjacent pixel correlation flag of “1” on one line.

Comparing circuit 144 compares the output of maximum value detecting circuit 143 with a predetermined horizontal continuity determination threshold. Comparing circuit 144 outputs “1” when the output of maximum value detecting circuit 143 is the horizontal continuity determination threshold or higher, or outputs “0” otherwise. Thus, the output of comparing circuit 144 is “1” in a line where many pixels of high correlation with their adjacent pixels are arranged consecutively in the horizontal direction (by the horizontal continuity determination threshold or more), or is “0” on the other lines. Thus, horizontal continuity determining section 55 determines the horizontal continuity.

Thus, horizontal continuity determining section 55 can detect the line where many pixels of high correlation with their adjacent pixels are arranged consecutively. In the present embodiment, the state where many pixels of high correlation with their adjacent pixels are arranged consecutively in the horizontal direction is referred to as “horizontal continuity is high”.

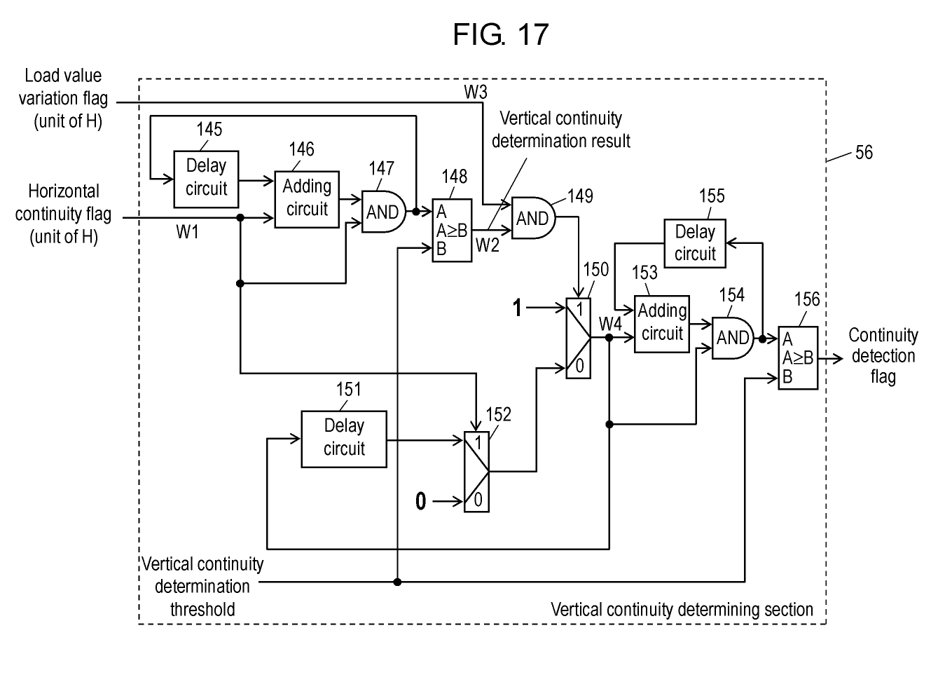

FIG. 17 is a circuit block diagram of vertical continuity determining section 56 in accordance with the exemplary embodiment of the present invention. Vertical continuity determining section 56 includes delay circuit 145, adding circuit 146, AND gate 147, comparing circuit 148, AND gate 149, selecting circuit 150, delay circuit 151, selecting circuit 152, adding circuit 153, AND gate 154, delay circuit 155, and comparing circuit 156.

Delay circuit 145, adding circuit 146, and AND gate 147 constitute a circuit for integrating the horizontal continuity flag output from horizontal continuity determining section 55 for each line. Specifically, adding circuit 146 adds the output of delay circuit 145 for delaying an input signal by one horizontal synchronizing period to the horizontal continuity flag. The addition result output from adding circuit 146 is input to delay circuit 145 via AND gate 147. Adding circuit 146 adds a new horizontal continuity flag to the output of delay circuit 145. By repetition of a series of these operations, the horizontal continuity flag is integrated in the vertical direction for each line.

AND gate 147 performs the logical product operation of the output of adding circuit 146 and the horizontal continuity flag, and resets the integration value of the horizontal continuity flag to “0” when the horizontal continuity flag is “0”. Thus, the output of AND gate 147 indicates the repetition count of the state where the horizontal continuity flag is “1”, namely indicates the number of vertically consecutive lines having a horizontal continuity flag of “1”, and indicates how many lines of high horizontal continuity are consecutively arranged in the vertical direction.

AND gate 147 resets the integration value of the horizontal continuity flag to “0” for each field. Therefore, the maximum value of the output of AND gate 147 becomes equal to the number of lines constituting panel 10 (the number of display electrode pairs 24). This reset can be performed by setting the horizontal continuity flag at “0” when the field is switched (the present field is switched to the next field), for example.

Comparing circuit 148 compares the output of AND gate 147 with a predetermined vertical continuity determination threshold. Comparing circuit 148 outputs “1” when the output of AND gate 147 is the vertical continuity determination threshold or higher, or outputs “0” otherwise. Thus, the output of comparing circuit 148 is “1” when many lines of high horizontal continuity are consecutively arranged in the vertical direction (the number of lines is the vertical continuity determination threshold or more), or is “0” otherwise. Thus, in the present embodiment, the vertical continuity is determined.

Thus, vertical continuity determining section 56 can determine whether or not the display image is an image where many lines of high horizontal continuity are consecutively arranged in the vertical direction. In the present embodiment, the state where many lines of high horizontal continuity are consecutively arranged in the vertical direction is referred to as “vertical continuity is high”.

AND gate 149 performs the logical product operation of the result of the vertical continuity determination output from comparing circuit 148 and the load value variation flag output from load value variation determining section 91. AND gate 149 outputs “1” when both of the output of comparing circuit 148 and the load value variation flag are “1”, or outputs “0” otherwise. Thus, of the lines having high vertical continuity, vertically adjacent lines between which the load value significantly differs can be detected. For such lines, the output of AND gate 149 is “1”.

Selecting circuit 150 selects and outputs one of two input signals based on the output of AND gate 149. Specifically, selecting circuit 150 selects “1” when the output of AND gate 149 is “1” or selects the output of selecting circuit 152 when the output of AND gate 149 is “0”, and outputs the selection result.

Delay circuit 151 delays the output of selecting circuit 150 by one horizontal synchronizing period.

Selecting circuit 152 selects and outputs one of two input signals based on the horizontal continuity flag. Specifically, selecting circuit 152 selects the output of delay circuit 151 when the horizontal continuity flag is “1” or selects “0” when the horizontal continuity flag is “0”, and outputs the selection result.

In other words, the circuit constituted by selecting circuit 150, delay circuit 151, and selecting circuit 152 performs the operation where, if the output of AND gate 149 becomes “1” once, the circuit continues to output “1” until the horizontal continuity flag becomes “0”.

Adding circuit 153, AND gate 154, and delay circuit 155 constitute a circuit for integrating the signal output from selecting circuit 150 for each line. Specifically, adding circuit 153 adds the output of selecting circuit 150 to the output of delay circuit 155 for delaying the input signal by one horizontal synchronizing period. The addition result output from adding circuit 153 is input to delay circuit 155 via AND gate 154. Adding circuit 153 adds a new output of selecting circuit 150 to the output of delay circuit 155. By repetition of a series of these operations, the output of selecting circuit 150 is integrated in the vertical direction for each line.

AND gate 154 performs the logical product operation of the output of adding circuit 153 and the output of selecting circuit 150, and resets the integration value output from adding circuit 153 to “0” when the output of selecting circuit 150 is “0”. Thus, the output of AND gate 154 indicates how many lines with a horizontal continuity flag of “1” occur consecutively, in the range from the line having a load value significantly different from that on its vertically adjacent line to the line having a horizontal continuity flag of “0”, of the plurality of lines of high vertical continuity.

The numerical value (output of AND gate 154) output from the circuit that is constituted by adding circuit 153, AND gate 154, and delay circuit 155 is “numerical value calculated based on the result of vertical continuity determination, the result of load value variation determination, and the result of horizontal continuity determination”.

AND gate 154 resets the integration value output from adding circuit 153 to “0” for each field. Therefore, the maximum value of the output of AND gate 154 becomes equal to the number of lines (the number of display electrode pairs 24) constituting panel 10. This reset can be performed by setting the horizontal continuity flag at “0” when the field is switched (the present field is switched to the next field), for example.

Comparing circuit 156 compares the output of AND gate 154 with the vertical continuity determination threshold. Comparing circuit 156 outputs “1” when the output of AND gate 154 is the vertical continuity determination threshold or higher, or outputs “0” otherwise.

Thus, vertical continuity determining section 56 can detect an image having many lines in the range from the line that has a load value significantly different from that on its vertically adjacent line to the line that has a horizontal continuity flag of “0”, of the plurality of lines of high vertical continuity, namely an image having many consecutive lines with a horizontal continuity flag of “1”.

In the present embodiment, such an image is referred to as “image apt to cause a loading phenomenon”. In other words, the comparison result in comparing circuit 156 is set as the determination result of the presence or the absence of occurrence of the loading phenomenon in the display image. In the present embodiment, thus, vertical continuity determining section 56 determines the presence or the absence of occurrence of the loading phenomenon in the display image.

In the present embodiment, the horizontal continuity determination threshold is set at 15% of the number of pixels on one line, and the vertical continuity determination threshold is set at 10% of the number of lines constituting panel 10. In the present invention, however, the respective thresholds are not limited to these numerical values. Preferably, the respective thresholds are set optimally based on the characteristics of panel 10, the specification of plasma display apparatus 1, the visibility test of the display image, and the experiment of displaying an image apt to cause the loading phenomenon on panel 10.

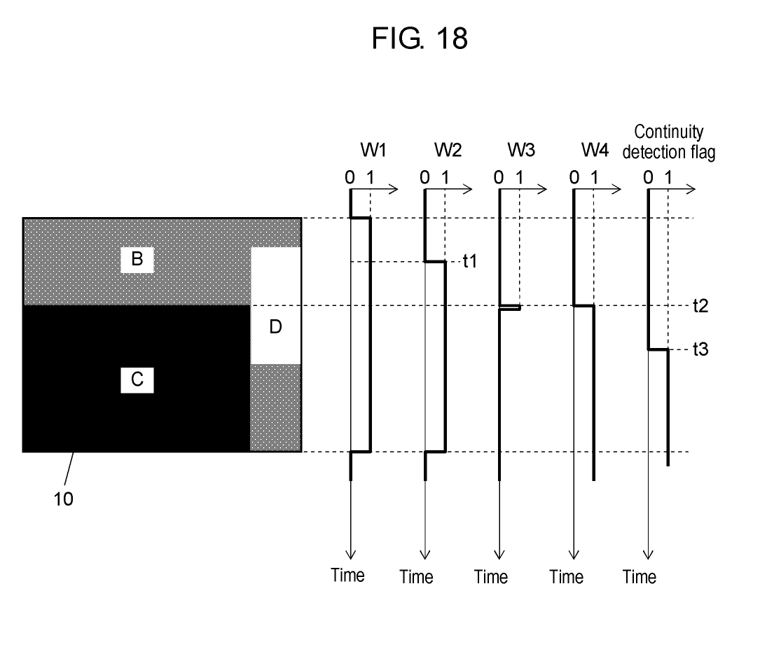

Next, one example of the operation of vertical continuity determining section 56 is described using drawings. FIG. 18 is a schematic diagram for illustrating an example of the operation of vertical continuity determining section 56 in accordance with the exemplary embodiment of the present invention. FIG. 18 schematically shows panel 10 displaying an image considered to be apt to cause the loading phenomenon, and schematically shows the operation of vertical continuity determining section 56 based on the image signal.

It is assumed that panel 10 displays an image where the region (region B in FIG. 18) of immediate luminance (e.g., 30%) is switched to the region (region C in FIG. 18) of low luminance (e.g., 0%) in the midway and the switching is positioned in the region (region D in FIG. 18) of high luminance (e.g., 100%). The following phenomenon is considered: when such an image is displayed on panel 10, the luminance becomes higher in a part of region D contact with region C than in a part of region D contact with region B, and the loading phenomenon is apt to occur in region D.

FIG. 18 shows the followings:
the horizontal continuity flag (“W1” in FIG. 17 and FIG. 18) input to adding circuit 146;
the output (“W2” in FIG. 17 and FIG. 18) of comparing circuit 148;
the load value variation flag (“W3” in FIG. 17 and FIG. 18) input to AND gate 149;
the output (“W4” in FIG. 17 and FIG. 18) of selecting circuit 150; and
the comparison result (continuity detection flag) of comparing circuit 156.
   In the graphs showing the outputs of the respective circuits, the vertical axis shows time and the horizontal axis shows the output value of each circuit.

In panel 10 showing an image considered to be apt to cause the loading phenomenon, the number of lines where pixels having high correlation with their adjacent pixels are arranged consecutively is larger than that when the other images are displayed. Therefore, when an image considered to be apt to cause the loading phenomenon is displayed on panel 10, the number of lines where the horizontal continuity flag is “1” is larger than that when the other images are displayed.

FIG. 18 shows an example where the horizontal continuity flag is “1” in all lines (graph W1). Adding circuit 146 continuously integrates the value of the horizontal continuity flag while the horizontal continuity flag is “1”, so that the output of AND gate 147 continues to increase during the integration. The output (graph W2) of comparing circuit 148 changes from “0” to “1” at time t1 when the output of AND gate 147 is the vertical continuity determination threshold or higher.

In the present embodiment, an image considered to be apt to cause the loading phenomenon is previously assumed, and the vertical continuity determination threshold is set so that the output of comparing circuit 148 changes from “0” to “1” when the image is displayed on panel 10.

While, load value variation determining section 91 can detect a place where the sum total of the load values significantly differs between vertically adjacent lines, by appropriately setting the load value level threshold, load value variation threshold, and load value variation determination threshold.

On such a line, the load value variation flag becomes “1”. In the example of FIG. 18, the sum total of the load values largely varies on the boundary between region B and region C shown by panel 10, so that the load value variation flag becomes “1” on the line positioned in the boundary as shown in graph W3.

The output of AND gate 149 becomes “1” at time t2 when both of the output of comparing circuit 148 and the load value variation flag become “1”. Thus, the output (graph W4) of selecting circuit 150 changes from “0” to “1” at time t2.

Adding circuit 153 continuously integrates the output of selecting circuit 150 while the output is “1”, so that the output of AND gate 154 continues to increase during the integration. At t3 when the output of AND gate 154 becomes the vertical continuity determination threshold or higher, the output of comparing circuit 156, namely the continuity detection flag, changes from “0” to “1”.

In the present embodiment, it is thus determined whether a pattern apt to cause the loading phenomenon is included in the display image. For the image where it can be determined that a pattern apt to cause the loading phenomenon is included, the continuity detection flag is set at “1”. For the other images, the continuity detection flag is set at “0”.

Next, details on adjusting coefficient generating section 65 are described.

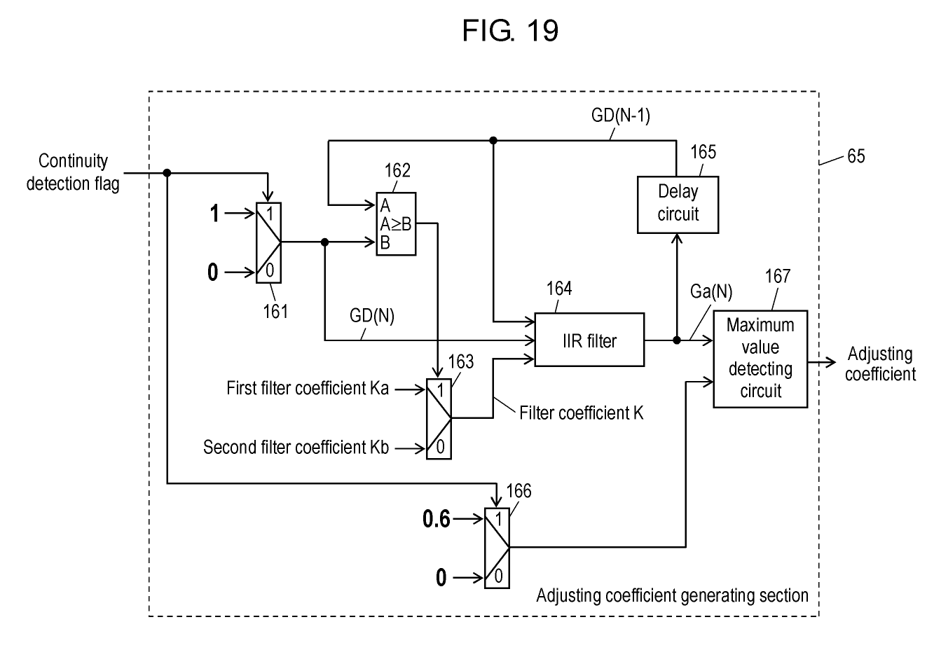

FIG. 19 is a circuit block diagram of adjusting coefficient generating section 65 in accordance with the exemplary embodiment of the present invention. Adjusting coefficient generating section 65 includes selecting circuit 161, comparing circuit 162, selecting circuit 163, infinite impulse response (IIR) filter 164, delay circuit 165, selecting circuit 166, and maximum value detecting circuit 167.

Selecting circuit 161 selects and outputs one of two input signals based on the continuity detection flag. Specifically, selecting circuit 161 selects “1” when the continuity detection flag is “1” or selects “0” when the continuity detection flag is “0”, and outputs the selection result. In the following descriptions, the output of selecting circuit 161 is referred to as GD(N).

Delay circuit 165 delays the output of IIR filter 164 by one vertical synchronizing period. In the following descriptions, the output of IIR filter 164 is referred to as Ga(N) and the output of delay circuit 165 is referred to as GD(N−1).

Selecting circuit 163 selects and outputs one of two input signals based on the output of comparing circuit 162. Specifically, selecting circuit 163 selects first filter coefficient Ka when the output of comparing circuit 162 is “1” or selects second filter coefficient Kb when the output of comparing circuit 162 is “0”, and outputs the selection result. In the following descriptions, the output of selecting circuit 163 is referred to as filter coefficient K. In the present embodiment, second filter coefficient Kb is set at a value larger than first filter coefficient Ka. As the value of each filter coefficient, first filter coefficient Ka is set at “0.5” and second filter coefficient Kb is set at “0.9”.

However, these numerical values are simply one example, and the respective filter coefficients are set optimally based on the characteristics of the panel and the specification of plasma display apparatus 1.

IIR filter 164 calculates output Ga(N) using GD(N) as the output of selecting circuit 161, GD(N−1) as the output of delay circuit 165, and filter coefficient K as the output of selecting circuit 163 in the following equation (5).

Ga(N)=GD(N)×K+GD(N−1)×(1−K) equation (5)

Therefore, in IIR filter 164, when first filter coefficient Ka is output from selecting circuit 163, the response speed of IIR filter 164 is relatively low and output Ga(N) converges relatively gently. When second filter coefficient Kb is output from selecting circuit 163, the response speed of IIR filter 164 is relatively high and output Ga(N) converges relatively sharply.

Comparing circuit 162 compares the output of selecting circuit 161 with output GD(N−1) of delay circuit 165. Comparing circuit 162 can detect whether the continuity detection flag changes from “0” to “1” or changes from “1” to “0”. For instance, when the continuity detection flag changes from “1” to “0”, the output of selecting circuit 161 is “0”, and the output of selecting circuit 161 is output GD(N−1) of delay circuit 165 or lower. When the continuity detection flag changes from “0” to “1”, the output of selecting circuit 161 is “1”, and the output of selecting circuit 161 is output GD(N−1) of delay circuit 165 or higher. Comparing circuit 162 outputs “1” when the output of selecting circuit 161 is output GD(N−1) of delay circuit 165 or lower, or outputs “0” otherwise. In the present embodiment, dependently on whether the continuity detection flag changes from “0” to “1” or changes from “1” to “0”, filter coefficient K used for IIR filter 164 is switched to one of first filter coefficient Ka and second filter coefficient Kb.

Selecting circuit 166 selects and outputs one of the two input signals based on the continuity detection flag. Specifically, selecting circuit 166 selects “0.6” when the continuity detection flag is “1” or selects “0” when the continuity detection flag is “0”, and outputs the selection result. The numerical value, “0.6”, selected when the continuity detection flag is “1” is set in consideration of the effect of the loading correction and variation in luminance generated by the loading correction. However, this numerical value is simply one example in the present embodiment, preferably is set optimally based on the characteristics of the panel and the specification of plasma display apparatus 1.

Maximum value detecting circuit 167 compares output Ga(N) of IIR filter 164 with the output of selecting circuit 166, and selects and outputs the larger one. The output of maximum value detecting circuit 167 is output as an adjusting coefficient from adjusting coefficient generating section 65 to correction gain adjusting section 64.

Therefore, in adjusting coefficient generating section 65, when the continuity detection flag changes “1” to “0”, selecting circuit 163 selects first filter coefficient Ka (e.g. 0.5), and Ga(N) output from IIR filter 164 relatively gently varies from “1” to “0”. At this time, selecting circuit 166 selects “0”, so that maximum value detecting circuit 167 outputs the output of IIR filter 164 as the adjusting coefficient as it is. When the continuity detection flag changes “0” to “1”, selecting circuit 163 selects second filter coefficient Kb (e.g. 0.9) higher than first filter coefficient Ka, and Ga(N) output from IIR filter 164 relatively steeply varies from “0” to “1”. At this time, selecting circuit 166 selects “0.6”, so that the adjusting coefficient output from maximum value detecting circuit 167 switches from “0” to “0.6”. Then, when the output of IIR filter 164 becomes “0.6” or higher, maximum value detecting circuit 167 outputs the output of IIR filter 164 as the adjusting coefficient as it is. In the present embodiment, the “gently” and “steeply” can be set using first filter coefficient Ka and second filter coefficient Kb used for IIR filter 164 and the set value used for selecting circuit 166.

Next, one example of the operation of adjusting coefficient generating section 65 is described using drawings.

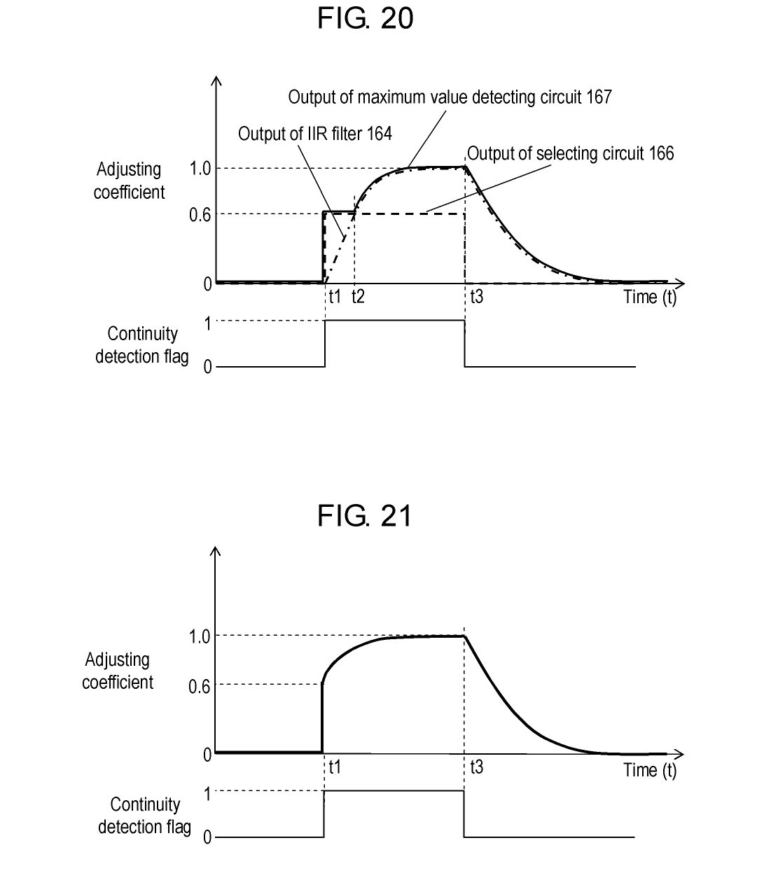

FIG. 20 is a schematic diagram for illustrating an example of the operation of adjusting coefficient generating section 65 in accordance with the exemplary embodiment of the present invention. The vertical axis of FIG. 20 shows the magnitude of the adjusting coefficient, and the horizontal axis shows time. In FIG. 20, the broken line shows the output of selecting circuit 166, the alternate long and short dash line shows the output of IIR filter 164, and the solid line shows the output of maximum value detecting circuit 167.

When the continuity detection flag changes from “0” to “1” at time t1, the output of selecting circuit 161 switches from “0” to “1”. Simultaneously, the output of selecting circuit 166 switches from “0” to “0.6”.

When the output of selecting circuit 161 is kept at “0” and the output of IIR filter 164 is also “0” until time t1, the adjusting coefficient output from maximum value detecting circuit 167 changes from “0” to “0.6” at time t1 when the output of selecting circuit 166 switches from “0” to “0.6”.

When the output of IIR filter 164 is “0” until time t1, the output of delay circuit 165 is also “0” at time t1. Therefore, the output (“1”) of selecting circuit 161 becomes larger than the output (“0”) of delay circuit 165 at time t1, and the output of comparing circuit 162 changes from “1” to “0”. Thus, at time t1, the output of selecting circuit 166 switches from first filter coefficient Ka to second filter coefficient Kb.

After time t1, second filter coefficient Kb is used in IIR filter 164, so that the output of IIR filter 164 steeply increases to “1” as the output of selecting circuit 161. At time t2 when the output of IIR filter 164 becomes larger than the output of selecting circuit 166, the adjusting coefficient output from maximum value detecting circuit 167 switches from “0.6” to the output of IIR filter 164.

After time t2, the adjusting coefficient increases at the rate of change responsive to the magnitude of second filter coefficient Kb while the continuity detection flag is “1” or until the adjusting coefficient reaches “1”.

When the continuity detection flag changes from “1” to “0” at time t3, the output of selecting circuit 161 switches from “1” to “0”. Simultaneously, the output of selecting circuit 166 switches from “0.6” to “0”.

The output (“0”) of selecting circuit 161 becomes smaller than the output of delay circuit 165 at time t3, so that the output of comparing circuit 162 changes from “0” to “1”. Thus, at time t3, the output of selecting circuit 166 is switched from second filter coefficient Kb to first filter coefficient Ka.

After time t3, first filter coefficient Ka is used in IIR filter 164, so that the output of IIR filter 164 gently decreases to “0” as the output of selecting circuit 161.

In the loading correction of the present embodiment, as discussed in FIG. 7, the image signal in the region expected to cause a loading phenomenon is corrected, and the emission luminance of the display image in the region is reduced, thereby reducing the loading phenomenon. Therefore, in order to prevent unnecessary variation in luminance in the display image, preferably, the loading correction is performed only when an image expected to cause a loading phenomenon is displayed. In the present embodiment, pattern detecting section 63 can determine whether or not a pattern apt to cause a loading phenomenon is included in the display image by appropriately setting each threshold. Therefore, by employing a configuration where the correction gain output from correction gain calculating section 62 is adjusted based on the determination result (continuity detection flag), the loading correction can be performed only when an image expected to cause a loading phenomenon is displayed and the unnecessary variation in luminance in the display image can be reduced.

Further, steep variation in luminance in the display image can be prevented in the following method. The adjusting coefficient is steeply increased from “0” to “1” when the continuity detection flag changes from “0” to “1”, and the adjusting coefficient is gently decreased from “1” to “0” when the continuity detection flag changes from “1” to “0”. Thus, the loading correction is rapidly applied to the display image when an image determined to cause a loading phenomenon is displayed, and the loading correction is released gently when the image determined to cause the loading phenomenon is switched to an image determined to cause no loading phenomenon.

In the present embodiment, even when the continuity detection flag becomes “1” in the midway of the image, the same adjusting coefficient is assumed to be used in all regions. Therefore, after the determination result by pattern detecting section 63 is obtained, appropriate time difference is set between the image signal input into pattern detecting section 63 and the image displayed on panel 10 so that the image as the base of the determination is displayed on panel 10. This operation is not shown.

As discussed above, in the present embodiment, the correction gain is calculated by calculating “load value” and “maximum load value” in each discharge cell. Thus, even in plasma display apparatus 1 having panel 10 where the difference in voltage drop of a sustain pulse is large between discharge cells formed on the same display electrode pair 24, the difference in driving load occurring between display electrode pairs 24 can be detected accurately and the optimal correction gain responsive to the lit state of the discharge cell can be calculated. Therefore, the correction gain responsive to the increase in emission luminance expected to be caused by the loading phenomenon can be calculated accurately and the loading correction can be performed accurately.

In the present embodiment, pattern detecting section 63 determines the presence or the absence of occurrence of a loading phenomenon in a display image, and adjusts the correction gain output from correction gain calculating section 62 based on the determination result. Thus, the loading correction can be rapidly applied to the display image when an image determined to cause a loading phenomenon is displayed. When the image determined to cause the loading phenomenon is switched to the image determined to cause no loading phenomenon, the loading correction is released gently to prevent steep variation in luminance from occurring in the display image. Therefore, the unnecessary variation in luminance in the display image can be reduced, and more accurate loading correction can be performed. Thus, the image display quality can be largely improved in plasma display apparatus 1 using panel 10 of a large screen and high definition.

In the present embodiment, FIG. 20 shows the configuration where the adjusting coefficient increases from “0” to “0.6” at time t1 when the continuity detection flag changes from “0” to “1”, the adjusting coefficient is kept at “0.6” in the period from time t1 to time t2, and the adjusting coefficient increases from “0.6” after time t2. However, the present invention is not limited to this configuration. FIG. 21 is a schematic diagram for illustrating another example of the generation of the adjusting coefficient in accordance with the exemplary embodiment of the present invention. For example, as shown in FIG. 21, the configuration may be employed where the adjusting coefficient is increased from “0” to “0.6” at time t1 when the continuity detection flag changes from “0” to “1”, and the adjusting coefficient is increased from “0.6” after time t1. The numerical value, “0.6”, is also simply one example. Preferably, the numerical value is set optimally based on the characteristics of panel 10 and the specification of plasma display apparatus 1.

In the present embodiment, the configuration has been described where adjusting coefficient generating section 65 outputs the larger one of the output of IIR filter 164 and the output of selecting circuit 166 and uses it as the adjusting coefficient. However, the present invention is not limited to this configuration. For example, the configuration may be employed where selecting circuit 166 and maximum value detecting circuit 167 are not used in the adjusting coefficient generating section, and the output of IIR filter 164 is output as the adjusting coefficient as it is.

In load value variation determining section 91, when one region load value variation determining section 54 operates, the other region load value variation determining sections 54 do not operate. Therefore, by employing the configuration where the integration value of region load value variation determining section 54 is reset for each region and its output is kept for a predetermined period (e.g., one horizontal synchronizing period), an operation equivalent to the operations of 16 region load value variation determining sections 54 can be achieved by one region load value variation determining section 54.

When the load value and maximum load value are calculated, before the calculation, the gradation value of the image signal is temporarily replaced by image data using a coding table where the gradation value is associated with the lighting or no-lighting of each subfield. This suggestion has been omitted in the description of loading correcting section 70 of FIG. 8: In the present embodiment, the luminance weight of each subfield is multiplied by the lit state of each subfield in the discharge cell when “load value” and “maximum load value” are calculated. However, the number of sustain pulses in each subfield may be used instead of the luminance weight, for example.

The following problem can occur: when image processing called error diffusion used in general is performed, the error amount diffused at the change point (boundary of the pattern of the display image) of the gradation value increases, and the boundary is emphasized in the boundary part of large variation in luminance and looks unnatural. In order to reduce the problem, the correction gain may be changed in a random manner by adding the correction value for error diffusion to the calculated correction gain in a random manner or subtracting it from the calculated correction gain in a random manner. Such processing can reduce the problem where the pattern boundary is emphasized and looks unnatural when the error diffusion is performed.

In the present embodiment, “to determine the presence or the absence of occurrence of a loading phenomenon in a display image” means determination of whether or not the loading phenomenon occurs when an image is displayed on panel 10 without applying loading correction to the display image, and does not mean that the presence or the absence of occurrence of a loading phenomenon is determined in a display image after the loading correction.

The exemplary embodiment of the present invention can be applied to a panel driving method by the so-called two-phase driving: scan electrode SC1 through scan electrode SCn are classified into the first scan electrode group and the second scan electrode group, and the address period is constituted by the first address period for applying a scan pulse to each of scan electrodes belonging to the first scan electrode group and the second address period for applying a scan pulse to each of scan electrodes belonging to the second scan electrode group. Also in this case, an effect similar to the above-mentioned one can be produced.

The exemplary embodiment of the present invention can be applied to a panel having an electrode structure where a scan electrode is adjacent to another scan electrode and a sustain electrode is adjacent to another sustain electrode, namely an electrode structure where the electrode array disposed on the front substrate is “ . . . , scan electrode, scan electrode, sustain electrode, sustain electrode, scan electrode, scan electrode, . . . ”.

Each circuit block shown in the exemplary embodiment of the present invention may be configured as an electric circuit for performing each operation shown in the exemplary embodiment, or may be configured using a microcomputer or the like programmed so as to perform a similar operation.

In the present embodiment, an example where one pixel is formed of discharge cells of three colors R, G, and B has been described. However, also in a panel where one pixel is formed of discharge cells of four or more colors, the configuration shown in the present embodiment can be applied and a similar effect can be produced.

Each specific numerical value shown in the exemplary embodiment of the present invention is set based on the characteristics of panel 10 having a screen size of 50 inches and having 1080 display electrode pairs 24, and is simply one example in the embodiment. The present invention is not limited to these numerical values. Numerical values are preferably set optimally in response to the characteristics of the panel or the specification of the plasma display apparatus. These numerical values can vary in a range allowing the above-mentioned effect. The number of subfields and luminance weight of each subfield are not limited to the values shown in the exemplary embodiment of the present invention, but the subfield structure may be changed based on an image signal or the like.

### INDUSTRIAL APPLICABILITY

The present invention can provide a plasma display apparatus and a driving method for a panel that can reduce the variation in luminance caused in a display image by the difference in driving load between display electrode pairs and improve the image display quality by reducing unnecessary variation in luminance in the display image, even when the panel has a large screen and high definition. Therefore, the present invention is useful as a plasma display apparatus and a driving method for a panel.

### REFERENCE MARKS IN THE DRAWINGS

1 plasma display apparatus
10 panel
21 front substrate
22 scan electrode
23 sustain electrode
24 display electrode pair
25, 33 dielectric layer
26 protective layer
31 rear substrate
32 data electrode
34 barrier rib
35 phosphor layer
41 image signal processing circuit
42 data electrode driver circuit
43 scan electrode driver circuit
44 sustain electrode driver circuit
45 timing generation circuit
51 horizontally-adjacent pixel correlation determining section
52 vertically-adjacent pixel correlation determining section
53 RGB level determining section
54 region load value variation determining section
55 horizontal continuity determining section
56 vertical continuity determining section
60 number-of-lit-cells calculating section
61 load value calculating section
62 correction gain calculating section
63 pattern detecting section
64 correction gain adjusting section
65 adjusting coefficient generating section
68 multiplier
69 correcting section
70 loading correcting section
90 adjacent pixel correlation determining section
91 load value variation determining section
92 continuity determining section
101, 104, 107, 111, 114, 117, 126, 131, 140, 145, 151, 155, 165 delay circuit
102, 105, 108, 112, 115, 118, 132 subtracting circuit
103, 106, 109, 113, 116, 119, 121, 122, 123, 133, 134, 135, 139, 144, 148, 156,
162 comparing circuit
110, 120, 125, 137, 142, 147, 149, 154 AND gate.
124, 136 OR gate
130 load value sum total calculating circuit
138, 141, 146, 153 adding circuit
143 maximum value detecting circuit
150, 152, 161, 163, 166 selecting circuit
164 IIR filter
167 maximum value detecting circuit

1. A plasma display apparatus comprising:
a plasma display panel that has a plurality of discharge cells each of which has a display electrode pair including a scan electrode and a sustain electrode, and a plurality of pixels each of which has a plurality of discharge cells for emitting lights in different colors; and
an image signal processing circuit for converting an input image signal into image data that indicates lighting or no-lighting in each subfield in the discharge cells,
wherein the image signal processing circuit includes:
a number-of-lit-cells calculating section for calculating the number of discharge cells to be lit for each display electrode pair in each subfield;
a load value calculating section for calculating the load value of each discharge cell based on a calculation result by the number-of-lit-cells calculating section;
a correction gain calculating section for calculating the correction gain of each discharge cell based on a calculation result by the load value calculating section;
a pattern detecting section for determining a presence or an absence of occurrence of a loading phenomenon in a display image;
an adjusting coefficient generating section for generating an adjusting coefficient based on a determination result of the pattern detecting section;
a correction gain adjusting section for generating a correction gain after adjustment by multiplying the correction gain by the adjusting coefficient; and
a correcting section for subtracting, from the input image signal, a result obtained by multiplying the input image signal by the correction gain after adjustment, and
wherein the pattern detecting section includes:
an adjacent pixel correlation determining section for determining correlation between the pixels adjacent to each other by comparing a gradation value assigned to each discharge cell in the pixel with that in its adjacent pixel;
a load value variation determining section for determining the load value variation by dividing the image display surface of the plasma display panel into a plurality of regions, by calculating a sum total of the load values in each of the plurality of regions, and by comparing the sum total of the load values in one of the regions with that in its adjacent region; and
a continuity determining section for determining the presence or the absence of occurrence of a loading phenomenon in a display image based on a result of correlation determination by the adjacent pixel correlation determining section and a result of the load value variation determination.

2. The plasma display apparatus of claim 1, wherein
the adjusting coefficient generating section has an IIR (Infinite Impulse Response) filter that is configured to switch and use a plurality of filter coefficients and generates the adjusting coefficient from a signal indicating a determination result of the pattern detecting section, and
when the determination result of the pattern detecting section changes from “absence” to “presence”, the IIR filter uses a filter coefficient larger than that when the determination result changes from “presence” to “absence”.

3. The plasma display apparatus of claim 2, wherein
the adjusting coefficient generating section has a selecting circuit for generating “0” when the determination result of the pattern detecting section is “absence” or generating a predetermined numerical value when the determination result is “presence”, and
the adjusting coefficient generating section outputs, as an adjusting coefficient, whichever a greater one between an output of the selecting circuit and an output of the IIR filter.

4. The plasma display apparatus of claim 3, wherein
the adjacent pixel correlation determining section comprises:
a gradation level determining section for performing level determination by comparing a gradation value assigned to each of the plurality of discharge cells which constitute one pixel with a level determination threshold;
a horizontally-adjacent pixel correlation determining section for determining the horizontally-adjacent pixel correlation, regarding two pixels which are the one pixel and a pixel adjacent to the one pixel disposed in an extending direction of the display electrode pairs, by calculating difference in gradation value between discharge cells of the same color and by comparing each difference with a horizontally-adjacent pixel threshold;
a vertically-adjacent pixel correlation determining section for determining the vertically-adjacent pixel correlation, regarding two pixels which are the one pixel and a pixel adjacent to the one pixel in a direction orthogonal to the display electrode pairs, by calculating difference in gradation value between discharge cells of the same color and by comparing each difference with a vertically-adjacent pixel threshold; and
a circuit for delaying a result of the vertically-adjacent pixel correlation determination obtained by the vertically-adjacent pixel correlation determining section by a time corresponding to one pixel, and
wherein the adjacent pixel correlation determining section performs the correlation determination by a logical product of a result of the level determination by the gradation level determining section, a result of the horizontally-adjacent pixel correlation determination by the horizontally-adjacent pixel correlation determining section, a result of the vertically-adjacent pixel correlation determination by the vertically-adjacent pixel correlation determining section, and an output of the circuit for delaying the result of the vertically-adjacent pixel correlation determination by the time corresponding to one pixel.

5. The plasma display apparatus of claim 3, wherein
the load value variation determining section sets the plurality of regions on the one display electrode pair,
the load value variation determining section has a region load value variation determining section, wherein the region load value variation determining section includes a load value sum total calculating circuit for calculating a sum total of the load values in the one region, a delay circuit for delaying an output of the load value sum total calculating circuit by one horizontal synchronizing period, and a subtracting circuit for calculating difference between the output of the load value sum total calculating circuit and an output of the delay circuit, and determines region load value variation in the one region, and
the load value variation determining section performs the load value variation determination by integrating results of the region load value variation determination in all regions set on the one display electrode pair and by comparing a result of the integration with a load value variation determination threshold.

6. The plasma display apparatus of claim 3, wherein
the continuity determining section includes:
a horizontal continuity determining section for determining horizontal continuity by integrating a result of the correlation determination in an extending direction of the display electrode pairs and by comparing a maximum value of an integration result with a horizontal continuity determination threshold; and
a vertical continuity determining section for determining vertical continuity by integrating a result of the horizontal continuity determination in a direction orthogonal to the display electrode pairs and by comparing an integration result with a vertical continuity determination threshold, and for comparing a numerical value calculated based on a result of the vertical continuity determination, a result of the load value variation determination, and a result of the horizontal continuity determination with the vertical continuity determination threshold.

7. The plasma display apparatus of claim 6, wherein
the correction gain changing section outputs one of “0” and the correction gain output from the correction gain calculating section based on a determination result by the pattern detecting section.

8. A driving method for a plasma display panel, the plasma display panel having a plurality of discharge cells each of which has a display electrode pair including a scan electrode and a sustain electrode, the plasma display panel having a plurality of pixels each of which has a plurality of discharge cells for emitting lights in different colors, the driving method comprising:
calculating the number of discharge cells to be lit for each display electrode pair in each subfield;
calculating a load value of each discharge cell based on the number of discharge cells to be lit and calculating a correction gain of each discharge cell based on the load value;
determining correlation by comparing a gradation value assigned to each discharge cell in a pixel with that in its adjacent pixel;
determining load value variation by dividing an image display surface of the plasma display panel into a plurality of regions, by calculating a sum total of the load values in each of the plurality of regions, and by comparing the sum total of the load values in one of the regions with that in its adjacent region;
determining a presence or an absence of occurrence of a loading phenomenon in a display image based on a result of the correlation determination and a result of the load value variation determination;
generating an adjusting coefficient based on the determination result and generating a correction gain after adjustment by multiplying the correction gain by the adjusting coefficient; and
multiplying an input image signal by the correction gain after the adjustment, subtracting a multiplication result from the input image signal for correcting the input image signal.

9. The driving method for the plasma display panel of claim 8, the driving method comprising:
generating the adjusting coefficient from a signal indicating the determination result using an IIR (Infinite Impulse Response) filter; and
speeding up a response of the IIR filter by setting a filter coefficient in the IIR filter at a numerical value, the numerical value being larger when the determination result changes from “absence” to “presence” than that when the determination result changes from “presence” to “absence”.

10. The driving method for the plasma display panel of claim 9, the driving method comprising:
generating “0” when the determination result is “absence” or generating a predetermined numerical value when the determination result is “presence”, and
outputting, as an adjusting coefficient, whichever a greater one between the generated numerical value and an output of the IIR filter.

11. The driving method for the plasma display panel of claim 10, the driving method comprising:
performing level determination by comparing a gradation value assigned to each of the plurality of discharge cells which constitute one pixel with a level determination threshold;
determining a horizontally-adjacent pixel correlation, regarding two pixels which are the one pixel and a pixel adjacent to the one pixel disposed in an extending direction of the display electrode pairs, by calculating difference in gradation value between discharge cells of the same color and by comparing each difference with a horizontally-adjacent pixel threshold;
determining a vertically-adjacent pixel correlation, regarding two pixels which are the one pixel and a pixel adjacent to the one pixel disposed in a direction orthogonal to the display electrode pairs, by calculating difference in gradation value between discharge cells of the same color and by comparing each difference with a vertically-adjacent pixel threshold; and
performing the correlation determination by a logical product of a result of the level determination, a result of the horizontally-adjacent pixel correlation determination, a result of the vertically-adjacent pixel correlation determination, and a result obtained by delaying the result of the vertically-adjacent pixel correlation determination by a time corresponding to one pixel.

12. The driving method for the plasma display panel of claim 10, the driving method comprising:
setting the plurality of regions on the one display electrode pair;
determining region load value variation in the one region by calculating sum total of the load values in the one region, by delaying the sum total of the load values by one horizontal synchronizing period, and by calculating difference between the sum total of the load values and the sum total of the load values delayed by one horizontal synchronizing period; and
performing the load value variation determination by integrating results of the region load value variation determination in all regions set on the one display electrode pair and by comparing a result of the integration with a load value variation determination threshold.

13. The driving method for the plasma display panel of claim 12, the driving method comprising:
determining horizontal continuity by integrating a result of the correlation determination in the extending direction of the display electrode pairs and by comparing a maximum value of an integration result with a horizontal continuity determination threshold; and
determining vertical continuity by integrating a result of the horizontal continuity determination in the direction orthogonal to the display electrode pairs and by comparing an integration result with a vertical continuity determination threshold, and comparing a numerical value calculated based on a result of the vertical continuity determination, a result of the load value variation determination, and a result of the horizontal continuity determination with the vertical continuity determination threshold.

14. The driving method for the plasma display panel of claim 13, wherein
one of “0” and the correction gain is selected based on a determination result of the presence or the absence of the occurrence of the loading phenomenon.
